(19) United States
(12) Patent Application Publication
(10) Pub. No.: US 2016/0199752 A1
(43) Pub. Date: Jul. 14, 2016

(54) Fiber Based Molecularly Imprinted Polymers for the Removal of a Significant Fraction of Target Imprintable Entities

(71) Applicant: The Decaf Company, LLC, Danville, CA (US)

(72) Inventors: James Paul Farr, Dublin, CA (US); Marion Melvin Stuckey, Danville, CA (US); Michael John Petrin, Walnut Creek, CA (US); William Paul Sibert, Danville, CA (US)

(73) Assignee: The Decaf Company, LLC, Danville, CA (US)

(21) Appl. No.: 14/993,898

(22) Filed: Jan. 12, 2016

Related U.S. Application Data
(60) Provisional application No. 62/125,168, filed on Jan. 13, 2015.

(51) Int. Cl. B01D 15/20; D04H 13/00; D03D 15/00

(52) U.S. Cl. CPC B01D 15/20; D03D 15/0027; D04H 13/00

(57) ABSTRACT

An apparatus for extraction of a significant fraction of targeted imprintable entities (TIEs) from fluid ounce size or larger quantities of a fluid includes a polymer fiber with a quantity of molecularly imprinted polymer binding sites disposed on a surface of the fiber. The binding sites are suitable for extraction of any pathogen, virus, bacteria, toxin, poison, pollutant, desired or undesired compound, molecule or other object from the fluid that can be imprinted into the fiber surface. The fibers are spooled, woven or non-woven, spun-woven, layered, contained in a desired structure, formed into objects such as coffee filters or arranged in other patterns as desired to facilitate contact with a selected fluid or gaseous fluid. Any desired method of manufacture of the fiber or containment thereof is possible, as well as choice of monomers and subsequent polymers employed to form the fiber.

### PRIORITY

This application claims the benefit of U.S. provisional patent application No. 62/125168 entitled “Fiber Based Molecularly Imprinted Polymers for the Removal of a Significant Fraction of Target Imprintable Entities,” filed Jan. 13, 2015 by the same inventors, which is incorporated by reference as if fully set forth herein.

### BACKGROUND OF THE INVENTION

The present invention, in general, relates to molecularly imprinted polymers (MIPs) and, more particularly, to an apparatus or devices and methods for improving the efficacy of extraction of a significant fraction of target imprintable entities from a fluid utilizing molecularly imprinted polymers.

Polymeric fibers are conventionally known. Several fiber forming processes are capable of producing a wide range of fiber diameters, such as extrusion for micron-sized fibers. Because polymeric fibers can have a small diameter they are capable of exhibiting a large surface area to mass as well as a high pore volume and small pore size. However, polymeric fibers have not before been used for the extraction of a significant fraction of target imprintable entities imprinted along fiber surfaces or for the capture of other molecularly imprinted shapes (such as pathogens, etc. as described herein) that are present along the fiber surfaces in which milligram-scale or larger fluidic (liquid or gas) sample sizes are being treated.

Accordingly, there exists today a need for fiber based molecularly imprinted polymers for the extraction of a significant fraction of target imprintable entities that helps to ameliorate the well established problems and difficulties as well as provide additional capabilities.

### SUMMARY

It is an object of the present invention to provide a method and apparatus for the extraction of a significant fraction of target imprintable entities from a substantial quantity of a fluid.

It is also an important object of the invention to provide a method and apparatus for the extraction of a significant fraction of target imprintable entities from a substantial quantity of fluid in a shorter amount of time than previously available using MIPS.

Another object of the invention is to provide a method and apparatus for the extraction of a significant fraction of target imprintable entities from a substantial quantity of fluid using one or more molecularly imprinted polymeric fibers that help prevent inadvertent consumption of the molecularly imprinted fibers which are easier to contain than prior art MIP particles.

Still another object of the invention is to provide a method and apparatus for the extraction of a significant fraction of target imprintable entities from a substantial quantity of fluid using MIPS that allows for improved fluid flow and contact with the MIPS.

Still yet another object of the invention is to provide a method and apparatus for the extraction of a significant fraction a significant fraction of target imprintable entities from a substantial quantity of fluid using MIPS wherein the MIPS are disposed along an exterior surface of a polymer fiber.

Yet another important object of the invention is to provide a method and apparatus for the extraction of a significant fraction of target imprintable entities from a substantial quantity of fluid using MIPS that are disposed along an exterior surface of a polymer fiber and wherein the fiber includes a desired shape.

Still yet another important object of the invention is to provide a method and apparatus for the extraction of a significant fraction of target imprintable entities from a substantial quantity of fluid using MIPS that are disposed along an exterior surface of a polymer fiber and wherein the fiber includes a ball or a spool or a web or a layer or a matrix or other three dimensional form of fiber, and/or a space-filling collection of a plurality of fibers.

A first continuing object of the invention is to provide a method and apparatus for the extraction of a significant fraction of target imprintable entities from a substantial quantity of fluid using MIPS that are disposed along an exterior surface of a polymer fiber and wherein the fiber includes a woven fiber material.

A second continuing object of the invention is to provide a method and apparatus for the extraction of a significant fraction of target imprintable entities from a substantial quantity of fluid using MIPS that are disposed along an exterior surface of a polymer fiber and wherein the fiber includes a non-woven fiber.

A third continuing object of the invention is to provide a method and apparatus for the extraction of a significant fraction of target imprintable entities from a substantial quantity of fluid using MIPS that are disposed along an exterior surface of a polymer fiber and wherein the fiber includes a filter, and wherein the filter can include a single layer or multiple layers, and wherein the filter can be woven or non-woven, and wherein the filter can include any desired shape including, among others, a web, a sheet, a sponge, a disc, a cylinder, a cone, a cube, a matrix, a layered shape or the like, or alternatively can be formed into and/or constrained by any means into any desired three dimensional form, such as a rod, stir bar, spoon, wand or the like.

A fourth continuing object of the invention is to provide a method and apparatus for the extraction of a significant fraction of target imprintable entities from a substantial quantity of fluid using MIPS that are disposed along an exterior surface of a polymer fiber and wherein the fiber includes a housing that is able to contain a sufficient quantity of the fiber and/or a plurality of fibers.

A fifth continuing object of the invention is to provide a method and apparatus for the extraction of a significant fraction of target imprintable entities from a substantial quantity of fluid using MIPS that are disposed along an exterior surface of a polymer fiber and wherein the fiber includes a housing and wherein the housing includes a ball shape or a straw-like structure, or a whisk-shaped structure, or any other desired shape of structure.

A sixth continuing object of the invention is to provide a method and apparatus for the extraction of a significant fraction of target imprintable entities from a substantial quantity of fluid using MIPS that are disposed along an exterior surface of a polymer fiber and wherein the fiber is adapted for the removal of target imprintable entities from a beverage.

A seventh continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove contaminants, undesired drugs (for example, but not limited to date-rape drugs like rohypnol, ketamine and gamma-hydroxybutyrate) processing aids, color bodies (i.e., remove a color from the fluid such as for example, but not limited to caramel coloring or 4-methylimidazole), metals from a beverage, or artificial sweetener agents or sugar from a beverage.

An eighth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove target imprintable entities from an oil.

A ninth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove contaminants, processing aids, short-chain fatty acids that correlate with a rancid smell, or saturated trans-fats from an oil.

A tenth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to purify an oil for reuse.

An eleventh continuing object of the invention is to provide a method and apparatus for the extraction of a significant fraction of target imprintable entities from a substantial quantity of fluid using MIPs that are disposed along an exterior surface of a polymer fiber and wherein the fiber is adapted to remove metals or break-down products resulting from exposure to heat, air, pressure, mechanical action and/or wear and the like, from fluids.

A twelfth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove unhealthy and/or undesired components, such as monosodium glutamate (MSG) from soy sauce or other fluid condiments, sauces, marinates, juices, extracts and the like.

A thirteenth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to purify a precision cutting fluid.

A fourteenth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to purify a fluid used in aviation.

A fifteenth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove target imprintable entities from animal, for example, but not limited to blood, plasma, saliva, urine, stomach juices, intestinal juices, and the like.

A sixteenth continuing object of the invention is to provide a method and apparatus for the extraction of a significant fraction of target imprintable entities from a substantial quantity of fluid using MIPS that are disposed along an exterior surface of a polymer fiber and wherein the fiber is adapted for use in hemodialysis, and the fluid includes one or more of blood, plasma, a blood substitute, a blood diluent, and the like.

A seventeenth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove a toxin from a bloodstream.

An eighteenth continuing object of the invention is to provide a method and apparatus for the extraction of a significant fraction of target imprintable entities from a substantial quantity of fluid using MIPS that are disposed along an exterior surface of a polymer fiber and wherein the fiber is adapted for use in Antibody Drug Conjugation (ADC) where malignant cancer cells are tagged with artificial antibodies and specific toxins or poisons are used to kill the malignant cells, and wherein residual (i.e. left over) toxins are removed by the fibers.

A nineteenth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove toxins that occur as a result of illness, and such fluid includes blood, plasma and body exudates, and/or air and/or other fluids in contact with a human and/or an animal or other mammal suffering from the illness.

A twentieth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove a targeted virus from a bloodstream.

A twenty-first continuing object of the invention is to provide a method and apparatus for the extraction of a significant fraction of target imprintable entities from a substantial quantity of fluid using MIPS that are disposed along an exterior surface of a polymer fiber and wherein the fiber is adapted for the treatment of viral infections including influenza, Ebola and other viruses.

A twenty-second continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove a significant fraction (i.e., number or percentage) of target imprintable entities from the fluid for the purpose of reducing the overall level of target imprintable entities using the fibers which may include inventive webs.

A twenty-third continuing object of the invention is to provide a method and apparatus for the extraction of a significant fraction of target imprintable entities from a substantial quantity of fluid using MIPS that are disposed along an exterior surface of a polymer fiber and wherein the fiber is incorporated into a laminate of multiple webs, woven or non-woven, and wherein specific layers in the laminate exhibit differing properties.

A twenty-fourth continuing object of the invention is to provide a method and apparatus for the extraction of a significant fraction of target imprintable entities from a substantial quantity of fluid using MIPS that are disposed along an exterior surface of a polymer fiber and wherein the fiber is incorporated into a laminate of webs and wherein an uppermost first layer allows for a faster flow of the fluid into a middle layer, and wherein the middle layer is formed similar to a cotton ball and wherein the middle layer presents a significant amount of the fibers for contact with the fluid, and wherein a bottom layer is selected to include a weave or any desired tightness or looseness that provides a controlled rate of release of the fluid from the structure sufficient to allow adequate contact time of the fibers with the fluid and achieve a desired quantity of extraction of the target imprintable entities within a desired amount of time.

A twenty-fifth continuing object of the invention is to provide a method and apparatus for the extraction of a significant fraction of target imprintable entities from a substantial quantity of fluid using MIPS that are disposed along an exterior surface of a polymer fiber and wherein the fiber is formed to include a paper cup and wherein the paper cup includes a sleeve disposed therein that includes a quantity of the fibers.

A twenty-sixth continuing object of the invention is to provide a method and apparatus for the extraction of a significant fraction of target imprintable entities from a substantial quantity of fluid using MIPS that are disposed along an exterior surface of a polymer fiber and wherein exposure of the fluid with the fiber for a period of time provides an overall fractional reduction in the ratio of target imprintable entities remaining in the fluid as a reduction in degree to the extent of parts per million (PPM) of the target imprintable entities after exposure as compared to a significantly higher initial PPM of the target imprintable entities present prior to exposure.

A twenty-seventh continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove one or more desired target imprintable entities simultaneously.

A twenty-eighth continuing object of the invention is to provide a method and apparatus for the extraction of a significant fraction of target imprintable entities from a substantial quantity of fluid using MIPS that are disposed along an exterior surface of a polymer fiber and wherein the fiber is adapted to remove pathogens including viruses and bacteriophages, prions, toxins, poisons, pollutants or other desired or undesired compounds from the fluid, and wherein the fluid can include any fluid, aqueous solution, an oil or blood, or gaseous fluid such as air.

A twenty-ninth continuing object of the invention is to provide a method and apparatus for the extraction of a significant fraction of target imprintable entities from a substantial quantity of fluid using MIPS that can be used to remove viruses, pathogens, prions, microbes, germs, bacteria and other organisms from blood.

A thirtieth continuing object of the invention is to provide a method and apparatus for the extraction of a significant fraction of target imprintable entities from a substantial quantity of fluid using MIPS that is able to reduce a viral load in a body and which, accordingly, helps to provide additional time for a body's immune system to create a sufficient quantity of antibodies that are effective in combating the virus.

A thirty-first continuing object of the invention is to provide a method and apparatus for the extraction of a significant fraction of target imprintable entities from a substantial quantity of fluid using MIPS that provides an increase in a surface area of a polymer used for extraction of a significant fraction for a given weight (mass) of the polymer.

A thirty-second continuing object of the invention is to provide a method and apparatus for the extraction of a significant fraction of target imprintable entities from a substantial quantity of fluid using MIPS that provides an increase in a number of receptor sites disposed over a surface of a polymer for a given weight (mass) of the polymer.

A thirty-third continuing object of the invention is to provide a method and apparatus for the extraction of a significant fraction of target imprintable entities from a substantial quantity of fluid using MIPS that are disposed along an exterior surface of a polymer fiber and wherein the fiber includes a large aspect ratio and wherein the large aspect ratio includes a high length of the fiber with respect to a diameter of the fiber ratio, and/or a high cross-sectional aspect ratio with respect the fiber diameter, thereby providing a substantial increase in an effective surface area per gram of the fiber.

A thirty-fourth continuing object of the invention is to provide a method and apparatus for the extraction of a significant fraction of target imprintable entities from a substantial quantity of fluid using MIPS that are disposed along an exterior surface of a polymer fiber and wherein the MIPS are incorporated into the fiber during formation of the fiber, or wherein the MIPS are coated onto an existing type of a wire and/or other similar support structure, or an existing type of a fiber, or wherein the MIPS are attached to a surface of the fiber.

A thirty-fifth continuing object of the invention is to provide a method and apparatus for the extraction of a significant fraction of target imprintable entities from a substantial quantity of fluid using MIPS that are disposed along an exterior surface of a polymer fiber and wherein the fiber is formed utilizing any fiber forming technology including extrusion, electrospinning, melt spinning, gel spinning, dry spinning or any other desired method of formation.

A thirty-sixth continuing object of the invention is to provide a method and apparatus for the extraction of a significant fraction of target imprintable entities from a substantial quantity of fluid using MIPS that are disposed along an exterior surface of a polymer fiber and wherein the fiber includes a polymer, or a monomer or co-monomer used to form the resulting polymer, selected so as to form a TIE receptor site and/or template binding region on the subsequently formed polymer fiber wherein the receptor site is capable of adsorbing one or more selected TIEs with high specificity.

A thirty-seventh continuing object of the invention is to provide a method and apparatus for the extraction of a significant fraction of target imprintable entities from a substantial quantity of fluid using MIPS that are disposed along an exterior surface of a polymer fiber and wherein the fiber includes a fabric web.

A thirty-eighth continuing object of the invention is to provide a method and apparatus for the extraction of a significant fraction of target imprintable entities from a substantial quantity of fluid using MIPS that are disposed along an exterior surface of a polymer fiber and wherein the fiber is incorporated into a fabric web and wherein the fabric web is produced by wet-spinning, dry-spinning, melt-spinning, electro-spinning, melt blowing, spun-bonding, spin-lacing, needle-punching, carding, drawing, air-laying, wet-laying, hydro-entangling, weaving, bundling, bunching, depositing and/or solvent-casting and/or coating onto a support string or wire or membrane or surface of a supporting film or structure, confining and/or forming between two or more supporting fabrics, meshes, membranes, or the like; and/or other methods capable of producing a three-dimensional (3D) structure composed of the inventive MIP polymer fibers.

A thirty-ninth continuing object of the invention is to provide a method and apparatus for the extraction of a significant fraction of target imprintable entities from a substantial quantity of fluid using MIPS that are disposed along an exterior surface of a polymer fiber and wherein the fiber includes an interaction aid added thereto to enhance affinity of the target molecule to a binding site.

A fortieth continuing object of the invention is to provide a method and apparatus for the extraction of a significant fraction of target imprintable entities from a substantial quantity of fluid using MIPS that are disposed along an exterior surface of a polymer fiber and wherein the fiber is incorporated into a web and wherein the web increases surface availability of the MIPS to the fluid, and wherein the web features a pore size and/or range of pore sizes that help to optimize contact time of the fluid with the MIPS on the surface of the fiber, and wherein the web is optimized to facilitate flow-through of the fluid and other materials in the fluid that are not desired to be removed from the fluid.

A forty-first continuing object of the invention is to provide a method and apparatus for the extraction of a significant fraction of target imprintable entities from a substantial quantity of fluid using MIPS that are disposed along an exterior surface of a polymer fiber and wherein the fiber is incorporated into a web and wherein the web is layered in a manner to control a flow rate of the fluid there-through sufficient to control a duration of exposure of the fluid to the surface of the fiber.

A forty-second continuing object of the invention is to provide a method and apparatus for the extraction of a significant fraction of target imprintable entities from a substantial quantity of fluid using MIPS that are disposed along an exterior surface of a polymer fiber and wherein the fiber provides a significant increase in a surface area per gram of polymer as compared to a prior art crushed or ground MIPs.

A forty-third continuing object of the invention is to provide a method and apparatus for the extraction of a significant fraction of target imprintable entities from a substantial quantity of fluid using MIPS that are disposed along an exterior surface of a polymer fiber and wherein the fiber can be a nanofiber (a fiber having a diameter less than approximately 1 micron) and/or a plurality of nanofibers.

A forty-fourth continuing object of the invention is to provide a method and apparatus for the extraction of a significant fraction of target imprintable entities from a substantial quantity of fluid using MIPS that are disposed along an exterior surface of a polymer fiber and wherein the fiber is spun into a web and used to decrease a time required for extraction of a significant fraction of a predetermined quantity of target imprintable entities from a fluidic sample size that is equal to or greater than a milligram of fluid and wherein a desired fractional reduction of the target imprintable entities occurs as a result of fluidic exposure to the polymeric fiber web for a selected and/or desired period of time.

Briefly, an apparatus that is constructed in accordance with the principles of the present disclosure may include a polymer fiber with a quantity of molecularly imprinted polymer (MIP) binding sites disposed on a surface of the polymer fiber. A sufficient quantity of the binding sites have been treated to remove target imprintable entities therefrom that were used during formation of the molecularly imprinted polymer, thereby providing the binding sites which are available for capture and retention of additional target imprintable entities that are contained in a fluid that is exposed to the fiber surface. The apparatus is used specifically for extraction of a significant fraction of the target imprintable entities which includes extraction of milligram-scale or larger quantities of the fluid. The binding sites are imprinted with any molecular or other shape thereby rendering the binding sites suitable for high specificity extraction of any atom, metal, molecule, pathogen, virus, bacteria, toxin, poison, pollutant, desired or undesired compound, molecular complex, substance, or other object from the fluid that can be imprinted into the fiber surface. The fibers are spooled, woven, non-woven and/or layered, and contained in a desired structure, formed into a variety of desired objects such as coffee filters or arranged in other patterns as desired to facilitate contact with the fluid.

### BRIEF DESCRIPTION OF THE DRAWINGS

FIG. 1 is a view in perspective of a length of a non-woven polymeric fiber with a plurality of molecularly imprinted receptor sites on a surface thereof.

FIG. 2 is an enlarged view in perspective of a segment of the non-woven polymeric fiber of FIG. 1 illustrating a variety of possible different receptor site.

FIG. 3 is a view in perspective of the fiber of FIG. 1 arranged to form a sponge web.

FIG. 4 is a view in perspective of a disc type of filter.

FIG. 5 is a view in perspective of the fiber woven to form an upper disc filter and a lower disc filter and a sponge web disposed, there-between.

FIG. 6 is a view in perspective of the fiber of FIG. 1 disposed around a handle to form a swab or stirring stick.

FIG. 7 is a view in perspective of the fiber of FIG. 2 woven to form a cone type of coffee filter.

FIG. 8 is a view in perspective of a section of conduit that includes the sponge web of FIG. 3, the disc type of filter of FIG. 4, and a layer filter comprised of the upper disc filter, the lower disc filter and the sponge web of FIG. 5.

FIG. 9 is a plot of the log pressure drop versus bead diameters for various bed thicknesses for a comparative manual system for MIP polymer beads.

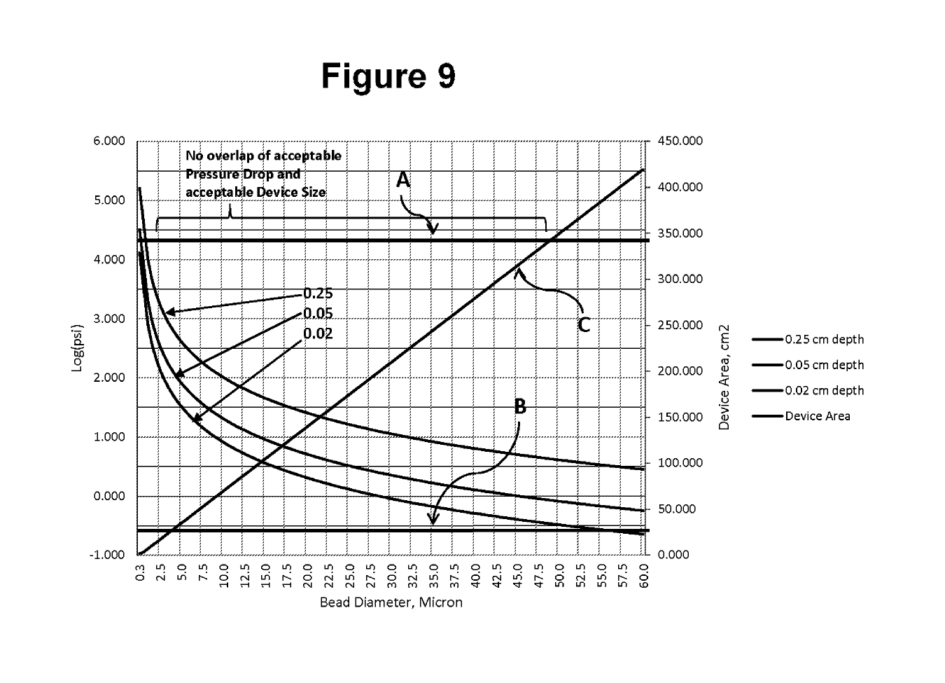

FIG. 10 is a plot of pressure drop versus fiber diameters for various web thicknesses, and also plotted against device area, for a manual system employing MIP polymer fibers.

FIG. 11 is a plot of pressure drop versus fiber diameters for various web thicknesses, and also plotted against device area, for a manual system employing MIP polymer fibers of various diameters to extract caffeine from a cup of coffee.

FIG. 12 is a plot of the log pressure drop versus bead diameters for various bed thicknesses (depths), and also plotted against device area, for a comparative gravity driven system attempting to use existing MIP polymer beads.

FIG. 13 is a plot of pressure drop versus fiber diameters for various web thicknesses, and also plotted against device area, for a higher pressure system employing MIP polymer fibers of various diameters.

FIG. 14 is a plot of pressure drop versus fiber diameters for various web thicknesses, and also plotted against device area, for a higher pressure (retail and/or commercial scale) system employing MIP polymer fibers of various diameters.

FIG. 15 is a plot of the log pressure drop versus bead diameters for various bed thicknesses plotted against device area, for a comparative higher pressure drop system attempting to use existing MIP polymer beads.

FIG. 16 is a plot of fiber diameters versus filter column height, for a higher pressure system employing MIP polymer fibers to extract caffeine from a process fluid with a target pressure drop of 40 psi and an extraction target of 20,000 g of caffeine using the inventive MIP polymer fibers.

FIG. 17 is a pictographic diagram of a commercial continuous flow process for a typical decaffeination scheme as it would employ inventive MIP polymer fibers in the form of a filtering apparatus operating under continuous process conditions.

FIG. 18 is a pictographic diagram of a commercial batch process for a typical decaffeination scheme as it would employ inventive MIP polymer fibers in the form of a filter plate apparatus operating under batch process conditions.

FIG. 19 is a plot of pressure drop versus fiber diameters for various web thicknesses, and also plotted against device area, for a filter mask employing MIP polymer fibers of various diameters to extract benzene from respired air, the inventive MIP polymer fibers in the form of a non-woven fabric of Areal value corresponding to 800 g/m2.

### DETAILED DESCRIPTION

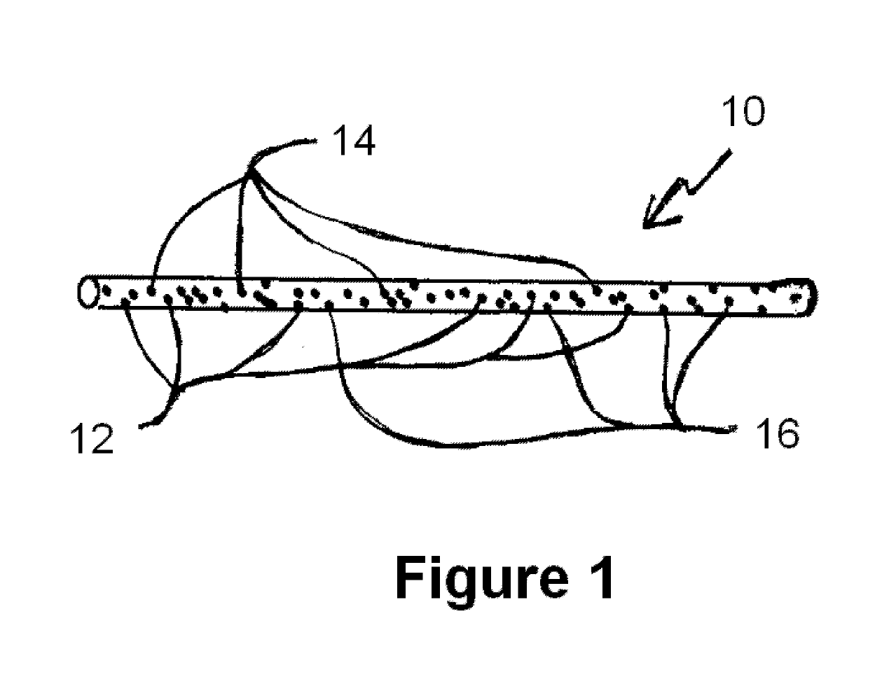

Referring on occasion to all of the Figure drawings and now, in particular to FIG. 1, is shown a perspective view of a length of a non-woven polymeric fiber, identified in general, by the reference numeral 10. The fiber 10 includes a variety of different molecularly imprinted receptor sites 12, 14, 16 on a surface thereof. Only a few of the many receptor sites 12, 14, 16 are specifically identified and labeled.

The reader will notice that reference is occasionally made throughout the disclosure suggesting that the reader refer to a particular drawing figure. The suggestion is at times made when the introduction of a new element requires the reader to refer to a different drawing figure than the one currently being viewed and also when the timely viewing of another drawing figure is believed to significantly improve ease of reading or enhance understanding. To promote rapid understanding of the instant invention the reader is encouraged to periodically refer to and review each of the drawing figures for possible cross-referencing of component parts and for other potentially useful information.

Certain examples are shown in the above-identified figures and are described in greater detail below. In describing these examples, like or identical reference numerals may be used to identify common or similar elements.

Because the fiber 10 contains the imprinted receptor sites 12, 14, 16 it is a type of a molecularly imprinted polymer (MIP). The fiber 10 is produced by any preferred fiber 10 forming technology or method including, but not limited to electrospinning, wet spinning, dry spinning, melt spinning, gel spinning, drawing or any other desired current or future method of fiber formation.

Conventionally crushed or ground MIPS are provided by the use of a polymer in liquid form that is saturated (as much as desired) with a large quantity of one or more types of target imprintable entities. The prior art polymer is then hardened by the use of a catalyst or any other preferred method to form a block. As the polymer solidifies it forms an accurate physical enclosure surrounding each of the objects (i.e., target imprintable entities). The polymer block is then crushed or finely ground which increases surface area and provides a quantity of crushed or ground MIPS. The MIPS are then treated (i.e., washed with any desired solution using any preferred method) to remove a maximum amount of the embedded target imprintable entities from the finely ground MIP surfaces leaving a significant quantity of available exposed (i.e., empty) binding sites. The available empty binding sites have an affinity for selectively attracting and retaining, therein, whatever object corresponds to the imprint of that binding site.

The term “target imprintable entity” or “target imprintable entities” (TIEs) is intended to encompass any substance for which an imprint in the polymer is accomplished. For example, any atom, metal, molecule, compound, toxin, small organism (or fragment thereof) or other type of object such as one or more types of pathogens may be disposed in the polymer liquid to yield various types of the binding sites 12, 14, 16.

For creation of fiber 10 MIP, the polymer is similarly saturated (or nearly so) with whatever objects are to be imprinted. The polymer is then hardened and formed into the fiber 10 by any preferred method. Alternately, as desired, the polymer may be formed into the fiber 10 and simultaneously or later hardened by any desired method. The fiber 10 is treated or washed using any preferred cleaning solution or method to provide an enormous quantity of the exposed (i.e., empty) molecularly imprinted receptor sites 12, 14, 16 on the surface of the fiber 10.

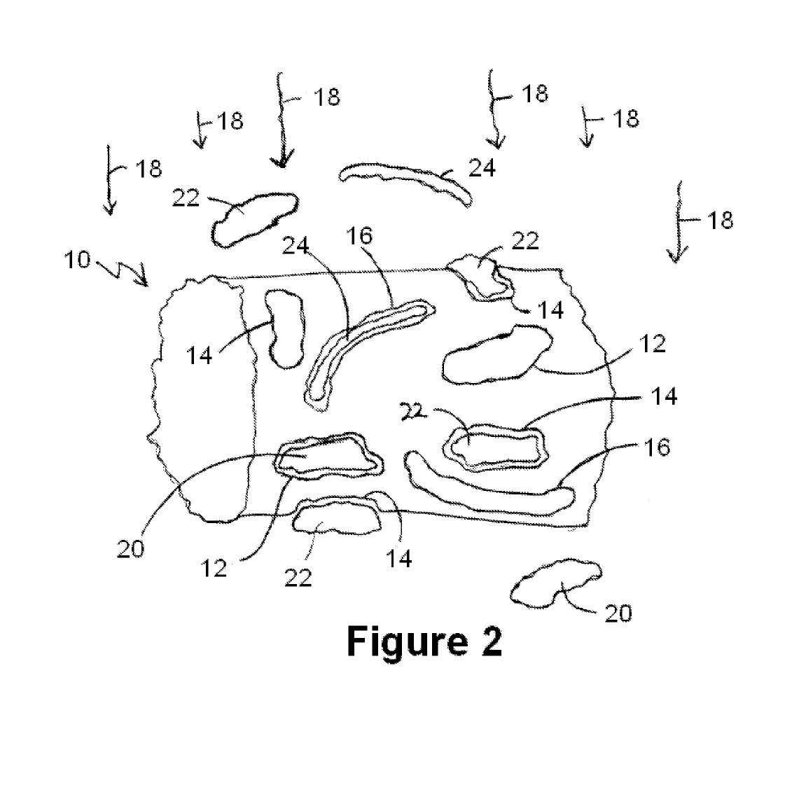

The fiber 10 can include any desired diameter or length. Often but not always, a small diameter is preferred as a means to maximize surface area, and therefore to significantly increase the number of available receptor sites 12, 14, 16, as compared to a mass (i.e., a weight) of the fiber 10 MIP. Maximizing surface area as compared to weight provides significantly more of the receptor sites 12, 14, 16 that are accessible to a fluid, as identified in FIG. 2 by arrows 18. The fluid 18 arrows also serve to indicate a general direction of movement (i.e., flow) of the fluid 18. This is discussed in greater detail, below.

Increasing surface area of the fibers 10 provides advantages that, in turn, significantly improve efficacy of extraction. Extraction is discussed in greater detail, below.

At times, that increased surface area must be balanced against increasing resistance to flow that occurs with smaller and smaller diameter fibers. Thus, while smaller fibers are advantageous in general, it is important to consider the device-specific requirements for acceptably low resistance to flow.

FIG. 2 show an enlarged view of a small segment of the non-woven polymeric fiber 10 of FIG. 1 better illustrating the various different receptor sites 12, 14, 16 and an ability to bind various objects, thereto.

It is to be understood that the following discussion provides a basic description of the smallest fraction of possible embodiments of the invention. It is impossible to include a description of all possible embodiments or to foresee all such embodiments. However, the disclosure provided herein is believed to be sufficiently enabling to permit those of reasonable and ordinary skill in this art or in the relevant arts to appreciate the wide range of benefits provided by the invention and, accordingly, adapt the disclosure for use in alternate embodiments consistent with the scope of the claims as appended, hereto. Accordingly, modifications to utilize the invention consistent with each stated object will become obvious to those possessing ordinary skill after having had benefit of the complete instant disclosure.

A first type of the receptor site 12 is shown and hereinafter referred to as the first receptor site 12. A second type of receptor site 14 is also shown as is a third type of receptor site 16, and are hereinafter referred to as the second receptor site 14 and the third receptor site 16.

While only an exceedingly limited number of the first, second and third receptor sites 12, 14, 16 are shown and described, it is to be understood that a substantially greater density of receptor sites 12, 14, 16 on the fiber 10 surface is anticipated in concert with a substantially longer fiber 10 and/or multiple longer lengths of the fiber 10, thereby providing a vastly greater number of the receptor sites 12, 14, 16.

The first receptor site 12, for the purpose of illustration, includes a physical imprint that corresponds with the shape of a portion of a caffeine molecule 20. Two of the first receptor sites 12 are shown on the fiber 10 segment, one of which includes the caffeine molecule 20 and a remaining one that is still empty. An extra caffeine molecule 20 is shown in suspension in the fluid 18. For this specific example, the fluid 18 is assumed to be an aqueous solution and more particularly caffeinated coffee that is being decaffeinated by contact with a vast quantity of the fiber 10. When the extra caffeine molecule 20 passes over (proximate) the remaining one of the first receptor site 12 it will be extracted from the fluid 18 and embedded in the available first receptor site 12.

If the sole purpose of the fiber 10 was to decaffeinate caffeinated aqueous solutions then the surface of the fiber 10 would be replete with a vast quantity of the first receptor site 12 only. It is possible to additionally include different receptor sites as well as the first receptor site 12 in the fiber 10 and this possibility is discussed in greater detail, below.

The second receptor site 14, for the purpose of a different illustration, includes a physical imprint that corresponds with the shape of a portion of a short-chain fatty acid molecule 22.

Four of the second receptor sites 14 are shown on the fiber 10 segment, three of which includes the short-chain fatty acid molecule 22 along with a remaining one of the second receptor sites 14 that is still empty. An extra short-chain fatty acid molecule 22 is shown in suspension in the fluid 18. For this specific example, the fluid 18 is assumed to be an oil and more particularly an olive oil that is being treated to remove the short-chain fatty acid molecules 22 that cause rancidity by contact with a vast quantity of the fiber 10.

If desired, the fluid 18 could alternately be a motor oil or a precision cutting fluid in which case the second receptor sites 14 would be imprinted to remove whatever contaminants were to be extracted from the respective type of oil.

When the extra short-chain fatty acid molecule 22 passes over (proximate) the remaining one of the second receptor sites 14 it will be extracted from the fluid 18 and embedded in the available empty second receptor site 14.

The fiber 10 can be produced to include only the one desired type (i.e., the second receptor site 14) or, as desired, multiple different types of other receptor sites, including the first receptor site 12 and/or the third receptor site 16 or variations, thereof, as is described in greater detail, below.

The third receptor site 16, for the purpose of a further different illustration, includes a physical imprint that corresponds with the shape of a portion of an Ebola virus 24. Two of the third receptor sites 16 are shown on the fiber 10 segment, one of which includes the Ebola virus 24 and a remaining one of the third receptor sites 16 that is still empty. Instead of the Ebola virus 24 a different receptor site (not shown) could be provided in the fiber 10 that included a partial physical imprint of any desired virus, bacteria, pathogen, toxin or other micro-organism as well as any desired combination, thereof.

An extra Ebola virus 24 is shown in suspension in the fluid 18. For this specific example, the fluid 18 is assumed to be a quantity of blood that is being treated by contact with a vast quantity of the fiber 10. When the extra Ebola virus 24 passes over (proximate) the remaining one of the third receptor sites 16 it will be extracted from the fluid 18 and embedded in the available third receptor site 16.

Accordingly, by removing a fractional amount of the Ebola virus 24 (or other pathogen) from the person's blood the person is afforded more time for his or her immune system to produce effective antibodies and rid the body of infection.

Sadly, the severity and speed of onset of disease, along with the damage caused by viral toxins that are produced by the Ebola virus 24 and by certain other viruses cause severe damage and death to many people that could be avoided if a way to maintain a lower viral load in the bloodstream of the person for a sufficient amount of time was available. The current invention represents a potential benefit to mankind of enormous value.

The lowering of the viral load in the bloodstream is not limited solely to human beings. This approach can be used with animal species as well as with human beings.

As an example of a further modification to improve efficacy in the treatment of viral infection (or any pathogenic infection caused by any microorganism) while still utilizing the Ebola virus 24 example, additional receptor sites could also be included in the fiber 10 that correspond with a partial imprint of one or more toxins that are produced by the Ebola virus 24.

Therefore, when passing the blood through a sufficient quantity of the fiber 10 containing a sufficient number of the third receptor sites 16 and the above-mentioned additional receptor sites for toxin removal, the viral load may be decreased at the same time (i.e., simultaneously) with a decrease in the amount of associated toxins in the bloodstream. The resultant toxins potentially are exceedingly harmful, even lethal, and therefore decreasing both the viral load simultaneously with a decrease in the amount of toxins has the potential to dramatically decrease the deleterious effects of the Ebola virus 24 or other disease organism.

According to this example, a large quantity of the fiber 10 with a sufficient quantity of the third receptor sites 16 adapted for extraction of one Ebola virus 24 along with a sufficient quantity of the above-mentioned additional receptor sites for toxin removal is accumulated to form an Ebola virus 24 and toxin filter of a preferred type and configuration. Filter type and configuration is described in greater detail below.

For the purpose of illustration, let us assume that a second similar filter is produced that is designed to extract the rabies virus and associated toxins. Continuing, let us assume that a third similar filter is produced that is designed to extract the current influenza virus and associated toxins. A fourth similar filter could be provided for malaria and a fifth similar filter for typhus. A sixth similar filter could be provided for the bacillus tetanus. Decreasing viral and toxin loading in the blood would be useful in delaying the severity of onset of these illnesses and could allow considerable additional time for the body's immune system to respond with an antibody solution that is able to rid the body of the disease.

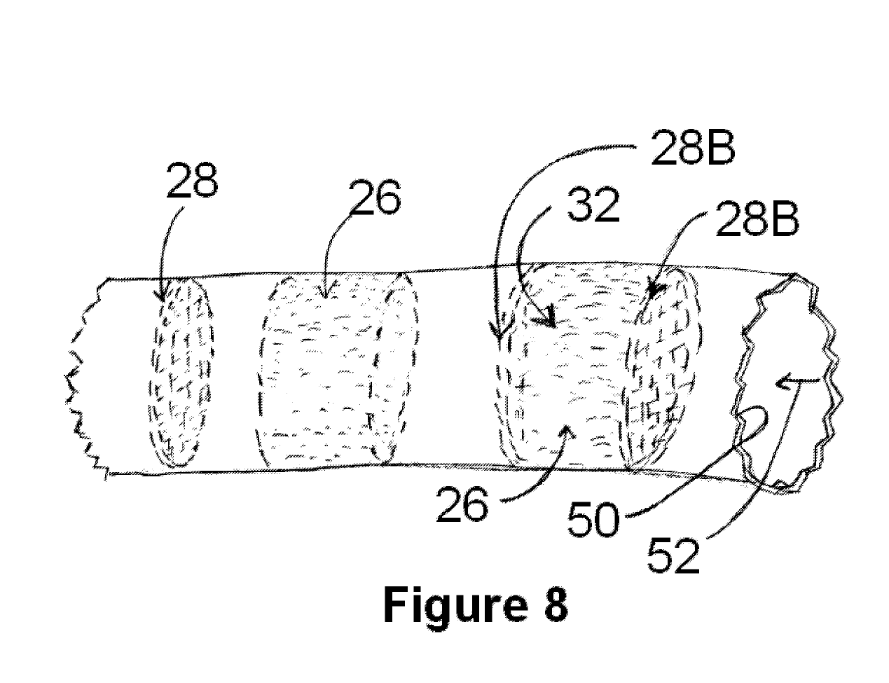

Accordingly, the proper filter would be selected to treat a person presenting one of these afflictions. The proper filter would be placed in a conduit (see FIG. 8 and accompanying description below) and the person's blood urged through the conduit and through the proper filter and back again, with a reduced viral (or bacterial) load and a reduced amount of associated toxins, being reintroduced into the person's bloodstream. Therefore, the severity of symptoms and the lethality of many vexing diseases are likely to be mitigated by the practice of the teachings, herein. Hospitals and even clinics in remote areas could benefit by then having a low cost and potentially highly effective and life-saving means available for treating these and a myriad of other diseases.

Increasing the number of the first, second, and third receptor sites 12, 14, 16 is essential to improving efficacy. The fiber 10 MIPS dramatically improves the ratio of surface area to the weight (mass) of the MIPS, thereby allowing lighter and potentially less expensive viable utilizations of the disclosed invention. Therefore, as small a diameter as is practically possible is preferred for the fiber 10 MIPS, while considering the need to keep resistance to flow (associated with smaller fibers) to a minimum.

Additionally, it is important to be able to contain the fiber 10 MIP while still allowing the fluid 18 to flow proximate the greatest number of receptor sites 12, 14, 16.

The greater the number of available first, second and third receptor sites 12, 14, 16 that the fluid 18 is exposed to the greater is the possibility that any given one of the caffeine molecules 20 or any given one of the short-chain fatty acid molecules 22 or any given one of the Ebola viruses 24 will be extracted from the respective type of the fluid 18.

On a large-enough scale this results in the extraction of a significant fraction of enough of the caffeine molecules 20, the short-chain fatty acid molecules 22, or the Ebola viruses 24 to produce a significant fractional reduction of the amount (in PPM or PPS) of the caffeine molecules 20, the short-chain fatty acid molecules 22, or the Ebola viruses 24 remaining in the fluid 18 after exposure to a sufficient quantity of the fiber 10.

Similarly, the greater the number of available first, second and third receptor sites 12, 14, 16 that the fluid 18 is exposed to, the shorter will be the time required to produce the desired fractional reduction result in a extraction of a significant fraction (i.e., over one milligram) of the fluid 18.

Therefore, this disclosure shows embodiments of various devices that are manufactured utilizing the previously described non-woven fiber 10 to optimize fluid 18 flow and enhance opportunities for fluid 18 contact with a sufficient number of the receptor sites 12, 14, 16 and to do so in a sufficiently short period of time.

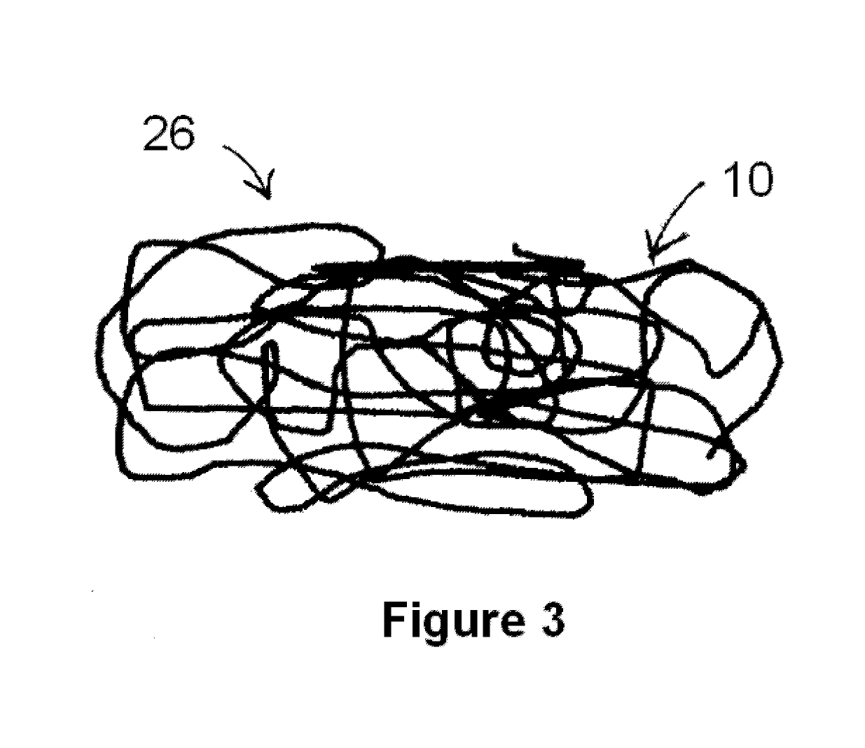

FIG. 3 shows a view in perspective of the fiber 10 arranged to form a sponge web, identified in general by the reference numeral 26. The sponge web 26 includes a desired continuous length of the fiber 10 that is accumulated in any desired fashion to form the structure of the sponge web 26. The sponge web 26 includes a thickness and a diameter (if cylindrical) or a length and width if rectangular. As much of the fiber 10, as desired, is used to form the sponge web 26. If desired, multiple distinct lengths of the fiber 10 are used to form the sponge web 26. If desired, the fiber 10 can include any of the receptor sites 12, 14, 16 or an accumulation of one or more other desired receptor sites. If the sponge web 26 is produced to be able to extract only one type of target molecule (i.e., either a large quantity of the caffeine molecules 20 only, or a large quantity of the short-chain fatty acid molecules 22 only, or a large quantity of the Ebola viruses 24 only) then the resultant sponge web 26 will have high specificity in rapidly extracting a large quantity of only the one target molecule. For certain applications this is preferred.

If, however, a plurality of different receptor sites 12, 14, 16 and possibly others are included in one or more of the fibers 10 that comprise the sponge web 26 then the resultant sponge web 26 will have high specificity in rapidly extracting a large quantity of more than one type of the target molecule simultaneously from the fluid 18. This may be preferred for certain applications.

The sponge web 26 can be compacted or open, as desired. The more the sponge web 26 is compacted, the smaller will be the pore size for passage of the fluid 18 around and through the sponge web 26. It is desirable to provide a sufficient length of the fiber 10 or plurality of fibers 10 that comprise the sponge web 26 to yield an adequate amount (or even an excess amount) of the receptor sites 12, 14, 16.

Assuming the diameter of the fiber 10 remains the same, compacting increases the amount of fiber 10 (i.e., the length of the fiber 10) present in any given size of the sponge web 26. However, compacting decreases the pore size which also proportionately decreases the rate of flow of the fluid 18 (for any given pressure) through the sponge web 26. Therefore, the degree of compaction is a design variable.

For certain applications, an unexpected ancillary benefit may also occur. This is best appreciated by reflecting momentarily on the mechanism by which the sponge web 26 extracts the target imprintable entities (according to the example, the caffeine molecules 20, the short-chain fatty acid molecules 22, or the Ebola viruses 24). The sponge web 26 functions as a filter to extract a quantity of the target imprintable entities. These target imprintable entities are allowed to pass freely through the gaps (pores) between the fibers 10 or overlays of any of the fibers 10.

The pore size between the fibers 10 does not obstruct or prevent passage of the target imprintable entities there-through. This is in contrast to conventional filters. In other words, the small pore size of a filter physically prevents passage of the pollen spores or red blood cells through the filter.

By way of comparison, the sponge web 26 (and other filter embodiments of the current invention) may deal with objects much smaller than pollen spores or red blood cells. Therefore, the pore size of the sponge web 26 might not significantly obstruct passage of the caffeine molecules 20, the short-chain fatty acid molecules 22, or the Ebola viruses 24 through the sponge web 26. Extraction of the caffeine molecules 20, the short-chain fatty acid molecules 22, or the Ebola viruses 24 is accomplished by binding with the empty receptor sites 12, 14, 16.

Except for controlling or regulating the time of exposure of the fluid 18 to the fiber 10, the pore size is not used to capture these smaller types of target imprintable entities. Additional description for controlling the rate of flow of the fluid 18, and thereby regulating the time of exposure of the fluid 18 to the fiber 10, is described in greater detail below.

A small pore size of an especially compacted embodiment of the sponge web 26 could be used to additionally physically capture larger objects, similar to that described above for prior art filters. In this manner, for example, the sponge web 26 could capture a quantity of the Ebola virus 24 in the third receptor sites 16 while simultaneously filtering out some wanted or unwanted object, for example a sufficiently large organism or pollutant or toxin that may also be present.

The accumulated fiber 10 of the sponge web 26 can be non-woven or woven as desired.

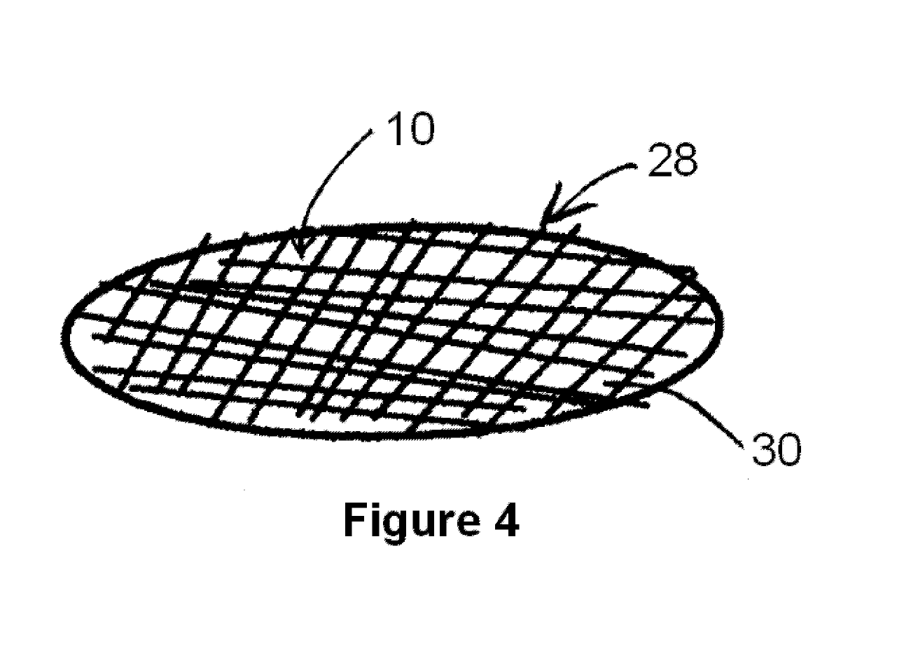

FIG. 4 shows a perspective view of the fiber 10 that has been woven to form a disc filter, identified in general by the reference numeral 28. The disc filter 28 includes any desired amount of the fiber 10 with any desired one or more of the first, second and/or third receptor sites 12, 14, 16 or combinations thereof or of other possible additional receptor sites. The fiber 10 is woven to form a grid pattern with any desired opening 30 size between the fibers 10. A smaller opening 30 size is useful in restricting a rate of flow of the fluid 18 and thereby in regulating a time of exposure of the fluid 18 to the fiber 10. This is described in greater detail, below.

Although shown as substantially circular in shape, the disc filter 28 can include any desired shape including triangular, square, rectangular or polygonal, and it can be configured into any desired depth or thickness.

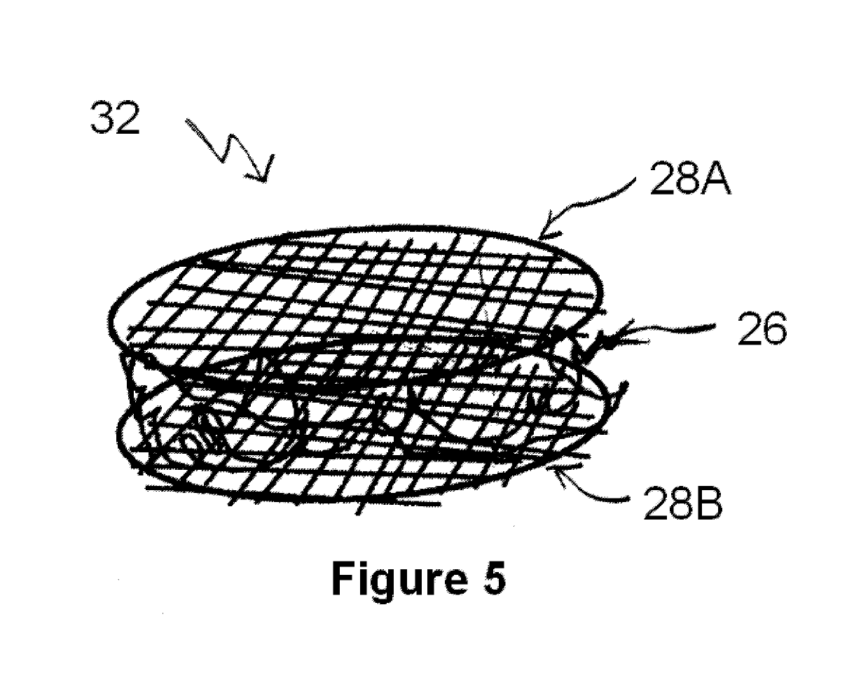

FIG. 5 shows a perspective view of a fiber 10 that has been woven to form a layered filter, identified in general by the reference numeral 32. The layered filter 32 includes an upper disc filter 28a and a lower disc filter 28b. A desired version of the sponge web 26 is disposed between the upper disc filter 28a and the lower disc filter 28b.

Any of the component parts of the layered filter 32 may include any desired amount of the fiber 10 with any desired one or more of the first, second and/or third receptor sites 12, 14, 16 or combinations thereof or combinations of any other possible additional type of receptor sites.

Considerable design flexibility and variability exists for the layered filter 32 as well as for all embodiments of the invention. An embodiment of the layered filter 32 may include a larger opening 30 size for the upper disc filter 28a and a smaller opening 30 size for the lower disc filter 28b, assuming that the direction of fluid 18 flow through the layered filter 32 is from the top downward.

The smaller opening 30 size of the lower disc filter 28b retards passage of the fluid 18 out of the layered filter 32. This is useful in regulating a time that the fluid 18 remains in contact with the fiber 10, which affects extraction of the target imprintable entities and, accordingly, the fractional decrease in the percentage of target imprintable entities remaining in the fluid 18 after exposure to the fiber 10. A smaller opening 30 size of the lower disc filter 28b increases the time for passage of the fluid 18 through the layered filter 32 and all other variable remaining the same, increases the fractional decrease in the remaining percentage of target imprintable entities.

It is also possible to modify the opening 30 size of the upper disc filter 28a and similarly affect flow rate of the fluid 18 through the layered filter 32 and the magnitude of fractional decrease that occurs.

Similarly, the physical structure of the sponge web 26 can be modified to include a smaller pore size (by compaction) or a larger pore size with similar changes in the rate of fluid 18 flow and modifications to the fractional decrease in target imprintable entities.

It is possible to vary any aspect of fluid 18 delivery as is known in the fluid 18 (or hydraulic) art field. For example, the fluid 18 can be conveyed through any desired type of the conduit (see FIG. 8) to reach and pass through the sponge web 26 or the disc filter 28 or the layered filter 32. Any means of controlling or regulating pressure is also possible. For example, gravity alone can be used to pass a caffeinated aqueous version of the fluid 18 through a version of the disc filter 28 that includes the first receptor sites 12 for the removal of the caffeine molecules 20 from the fluid 18. Alternately, any desired means for increasing pressure can be utilized to urge the fluid 18 under pressure through any desired embodiment of the invention.

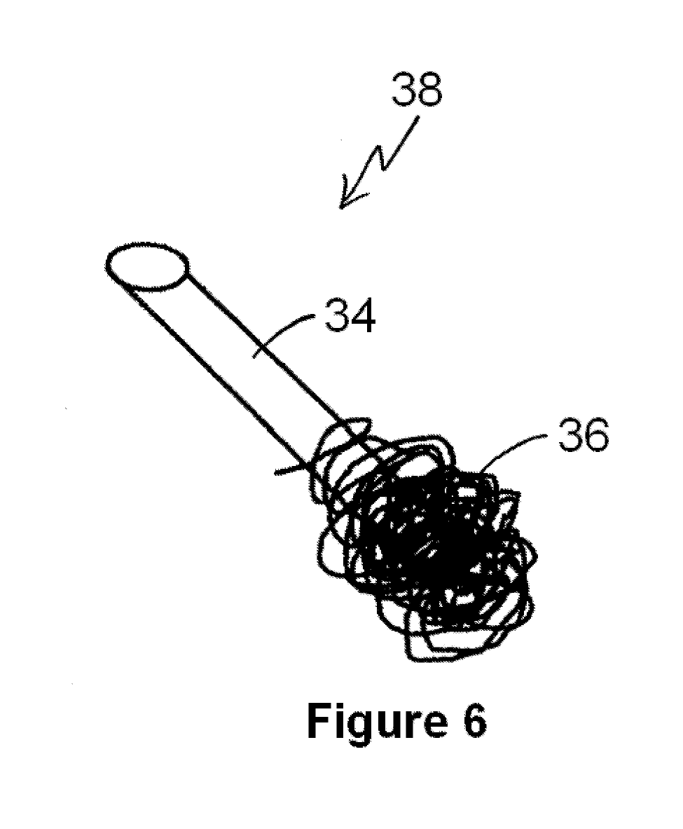

FIG. 6, is a perspective view of the fiber 10 coiled around a handle 34 to form a swab 36 at an end of the handle 34. Together the handle 34 and the swab 36 form a stirring stick, as identified in general by the reference numeral 38. As much of the fiber 10 MIP as desired is wrapped around the handle 34. One or more separate lengths of the fiber 10 are used to form the swab 36. The swab 36 end of the stirring stick 38 is immersed in the fluid 18 and simply stirred to bind and thereby remove whatever is imprinted on the fiber 10.

Continuing with another example utilizing the caffeine molecule 20, if a sufficient quantity of the fiber 10 is used to form the swab 36 and if the fiber 10 includes a sufficient quantity of the first receptor sites 12, then simply immersing the swab 36 end of the handle 34 into a caffeinated beverage, for example into a cup of coffee or a cup of tea, and stirring it for a sufficient period of time, will cause the beverage to experience a sufficient decrease in the percentage of remaining caffeine molecules 20. Therefore, after use of the stirring stick 38 and after removal of a significant-enough fraction of the caffeine molecules 20, the beverage will have been altered and can now be considered as a type of a decaffeinated beverage. This permits decaffeination of any preferred coffee or tea on the spot.

A high level of efficacy is achieved because of the significant increase in surface area and the resulting significant increase in the number of first receptor sites 12 provided by the use of the fiber 10, while also maintaining the desirably low resistance to fluid flow. Absent the use of polymeric fiber 10 MIPS the timely and significant extraction of a significant fraction fractional decrease in remaining target imprintable entities would not be possible and furthermore would not be possible in a reasonable amount of time, for example, a time requiring tens of seconds to effectively decaffeinate the beverage.

Certain embodiments of the invention are intended for single-use applications whereas other embodiments can be washed and reused repeatedly. For example, the stirring stick 38 is intended primarily for single-use applications where it is discarded after use. Accordingly, the handle 34 can be made of wood, plastic or any other desired material, and can optionally, further include some indicator means, as described herein below.

Similarly, referring to the example given for the treatment of Ebola, a version of the sponge web 26 filter, or the disc filter 28 or the layered filter 32 can be manufactured to include the third receptor sites 16 with imprints of the Ebola virus 24 and, as previously described, optional partial imprints of one or more toxins produced by the Ebola virus 24. Any of these filters (26, 28, 32) are placed in the desired conduit (see FIG. 8) and the person's blood is delivered as the fluid 18 to and through the filter (26, 28, 32) at a desired rate of flow to reduce the viral load and optionally to reduce the toxin load. After a period of time whatever type of the filter (26, 28, 32) that is used, is then replaced after a sufficient number of the third receptor sites 16 have been filled by a sufficient quantity of the Ebola virus 24 or after a sufficient number of toxin receptor sites are similarly filled. In this way, high efficacy at selectively removing a sufficient quantity of the Ebola virus 24 (and toxins) from the bloodstream is achieved to reduce the severity of symptoms and to allow the person's immune system to develop the antibodies necessary to eradicate the infection.

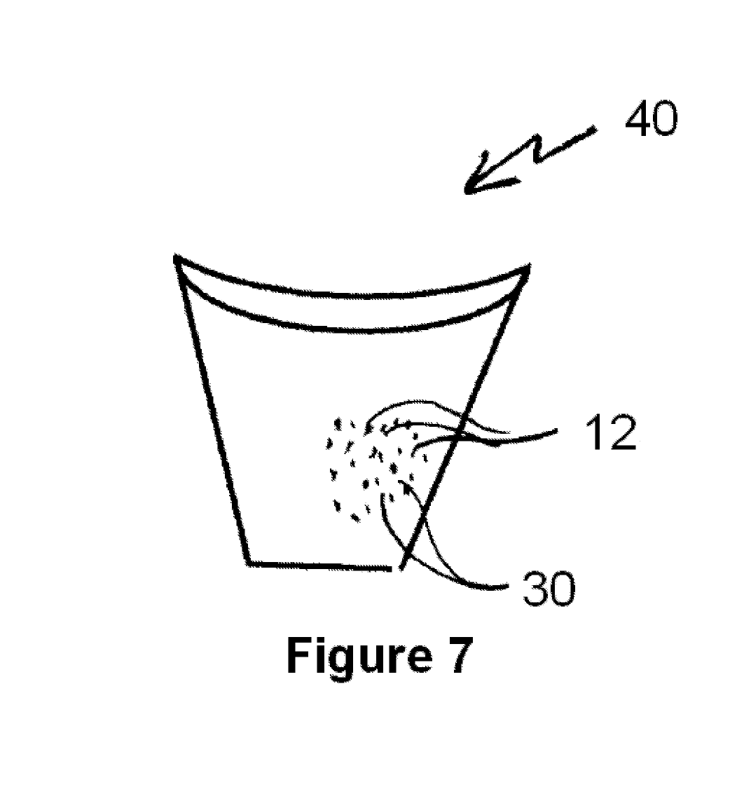

FIG. 7 is a perspective view of a fiber 10 laid to form a cone filter, identified in general by the reference numeral 40. The cone filter 40 can be laid in any desired manner. For example, an inter-weaved pattern of the fiber 10 can be utilized or the fiber 10 can be accumulated and bonded together (by heat or any preferred means) to form a fiber type of fabric. This is possible for all woven and non-woven embodiments of the fiber 10.

The fiber 10 that is used to form the cone filter 40 includes the first receptor sites 12 for the extraction of the caffeine molecules 20.

The tighter the lay, the smaller will be the openings 30 between the woven fibers 10. A tighter lay (i.e., smaller openings 30) will slow the rate of passage of a caffeinated beverage as the fluid 18 passes through the cone filter 40. Therefore, the tightness of the lay can be used to control the rate of flow of the fluid 18 (coffee or tea) through the cone filter 40 which in turn can be used to control the fractional reduction in remaining caffeine molecules 20 in the beverage after passage through the cone filter 40. A balance between fractional reduction and the magnitude of fractional reduction, as an expression of consumer preference, is a factor that can be used to create an optimal tightness of the lay.

Numerous other changes are also possible. For example, it is possible to modify the fiber 10 so that the fiber cross-sectional profile assumes any desired shape, including oval, tri-lobal, or multi-lobal, ruffled, pleated, or otherwise convoluted to have greater surface area than a round fiber or smooth cross-sectional profile, etc.

The versatility in imprinting the fiber 10 to include one or more different types of receptor sites is virtually unlimited. For example, considering use of the stirring stick 38, it is possible to include the first receptor sites 12 for the extraction of the caffeine molecules 20 and to also include a modification thereof to include additional receptor sites for the extraction of pesticides, fungicides, wanted or unwanted metals, wanted or unwanted minerals, wanted or unwanted compounds, harmful chemicals and/or bacteria and other pathogens. Therefore, the stirring stick 38 could be used with any beverage prior to consumption to reduce an intake of potentially harmful substances. If decaffeination is not desired while these other extractions are desired, then the stirring stick 38 is further modified to not include the first receptor sites 12.

FIG. 8 shows a perspective view of a section of conduit 50 that includes the sponge web 26 of FIG. 3, the disc filter 28 of FIG. 4, and the layered filter 32 of FIG. 5.

To illustrate one possible way of contacting the fluid 18 with the sponge web 26 or the disc filter 28 or the layered filter 32, all three filters 26, 28, 32 are shown in the section of conduit 50. While it is possible to include as many different filters (26, 28, 32) simultaneously, for most applications only one would typically be included in the section of conduit 50. However, the simultaneous inclusion of the sponge web 26, the disc filter 28 and the layered filter 32 is useful in illustrating a solution when either a high degree of filtration (i.e., a high fractional reduction) is desired or alternately when a variety of different objects (i.e., the caffeine molecule 20, the short-chain fatty acid molecule 22, and the Ebola virus 24) or any other combination of objects are to removed simultaneously.

If multiple different objects are being filtered (i.e., removed from the fluid 18 simultaneously) then the sponge web 26 could include a sufficient quantity of the first receptor sites 12, the disc filter 28 could include a sufficient quantity of the second receptor sites 14, and the layered filter 32 could include a sufficient quantity of the third receptor sites 16 to produce the desired fractional reduction of these three different objects as the fluid 18 flows through the section of conduit 50.

It is, of course, understood that for any embodiment of the invention the three objects (the caffeine molecule 20, the short-chain fatty acid molecule 22, and the Ebola virus 24) are intended to be illustrative and not limiting, and that alternate receptor sites for any desired objects that an imprint can be formed on the surface of the fiber 10 sufficient to bind the desired objects, thereto, are possible. It is also to be understood that when multiple different filters 26, 28, 32 are used simultaneously that any combination thereof or any combination of alternative filters of the invention can, instead, be simultaneously used.

Any filter 26, 28, 32 (or any alternative filter) may include multiple different receptor sites. For example, the sponge web 26 could include a sufficient quantity of the first and second receptor sites 12, 14 and/or the disc filter 28 could include a sufficient quantity of the second and third receptor sites 14, 16, and/or the layered filter 32 could include a sufficient quantity of the first and third receptor sites 12, 16. Any number of additional receptor sites can be included in any of the filters 26, 28, 32, as desired.

For purposes of illustration only, assume that the direction of fluid 18 flow is as shown by arrow 52. The resistance of all three filters 26, 28, 32 along with the pressure of the fluid 18 determine the rate of flow through the section of conduit 50. The fluid 18 is first contacted with the upper disc filter 28a. After passing through the upper disc filter 28a, the fluid 18 is contacted with the sponge web 26. As the fluid 18 exits the sponge web 26 it is contacted with the lower disc filter 28b.

As shown, the fluid 18 then passes through a small additional length of the section of conduit 50 and is then contacted with the stand-alone sponge web 26. The fluid 18 exits the stand-alone sponge web 26 and passes through a second small additional length of the section of conduit 50. The fluid 18 then passes through the stand-alone disc filter 28. After exiting, the fractional amount (a percentage reduction or a reduction in parts per million or parts per billion) of the objects (i.e., the caffeine molecule 20, the short-chain fatty acid molecule 22, and the Ebola virus 24) in a sufficient quantity of the fluid 18 to constitute extraction of a significant fraction of target imprintable entities from substantial quantities of fluid (i.e., at least one milligram of the fluid) has occurred.

A smaller version of section of conduit 50 can be provided and used to provide a filter straw. The filter straw can be used to purify a beverage of any number of undesired substances that it may contain as it is consumed. Use of the fiber 10 helps to prevent possible unintentional consumption of MIPS.

In the examples shown below, various embodiments of the present invention, including methods and apparatus configured to extract a significant fraction of a selected TIE are presented. Example embodiments explore the use of the inventive MIP fibers to extract milligram quantities of caffeine under low pressure conditions from a cup of coffee, to extract caffeine in kilogram quantities under higher pressure conditions that would be suitable for commercial processes, and example embodiments using the inventive MIP polymer fibers to extract milligram quantities of benzene as the selected TIE from air. These example embodiments are presented to illustrate some specific examples of how the inventive technology described herein can be used, and are not meant to limit the invention, these being examples rather to show the breadth and utility to which the inventive fibers can be adapted to extract any desired quantity of a TIE from any suitable fluid.

### SELECTED EXAMPLES

### MIP Polymer Fibers—Low Pressure and Gravity Flow Conditions

One embodiment of the present invention is a method of using MIP polymer fibers fashioned in some manner into the form of an easily handled apparatus in order to remove a significant fraction of a target imprintable entity (TIE)from a volume of fluid, for example, but not limited to removing a significantly large fraction of the caffeine present in a cup of coffee using caffeine imprinted MIP polymer fibers compressed into a fiber web and/or subsequently shaped into the form of a spoon or stir stick that can be introduced into the cup, stirred around for a requisite time, then removed and disposed of, leaving the coffee essentially free or at least greatly reduced in caffeine content.

To effectively remove a significant fraction of a TIE in quantities greater than about milligram levels from a unit fluid volume under low pressure or gravity flow conditions, there exists a trade-off between maximizing the surface area of the MIPS polymer fibers to have present a sufficient number of target binding sites to accommodate the amount of the targeted imprintable entity (TIE) desired for extraction, while retaining the fibers or the fiber bed in some stable physical manner to enable significantly complete removal of the TIEs from the fluid during the extraction process, and further maintaining the ability of the fluid to readily pass through and interact with the MIP sites without the need for applying excessive external pressure to create fluid flow through the MIP polymer fibers.

One issue is that to extract greater than milligram levels of a TIE from a unit fluid volume of about or greater than a fluid ounce typically requires such a large number of MIP sites that the resulting volume of MIP polymer could easily approach or even exceed the unit volume of the fluid to be treated. While this is not necessarily a limiting issue for a flow through system where the fluid to be treated could be filtered in-line for example, embodiments of the present invention that are envisioned for manual or hand use, for example in treating a fluid, a cup of coffee, a glass of water or other beverage or liquid, are preferably done using a treatment apparatus that is relatively small compared to the fluid volume, so as to facilitate stirring and also not to significantly displace the fluid from its container during treatment.

While one solution is to decrease the size (diameter) of the fiber to the nano-scale range, thus increasing the effective surface area of available MIP sites per unit polymer weight, this results in the issue of a significant pressure drop required to move a fluid, such as for example water, through the resulting nano-fibrous web compacted in volume to a working size having at the minimum a physical volume comparable to that of the unit fluid volume to be treated. For example, it would be desirable for some uses, such as using a MIP polymer fiber apparatus to remove significant amounts of caffeine from a cup of coffee, that the overall volume or size of the apparatus does not exceed that of the cup, and ideally would be desirable for the apparatus to be small enough in size not to displace significant amounts of fluid when placed into the cup, and even to have a negligible volume displacement when doing so, to enable stirring of the apparatus to facilitate the caffeine extraction process.

Compressing or compacting prior art nano-sized fibers (less than 1.0 microns) generally results in a compacted matrix that does not enable sufficient fluid flow to effect a significant removal of the target molecule in a reasonable time measured in seconds or minutes that are relevant for convenient consumer usage.

Surprisingly, the present invention solves this dilemma, and does so in a manner that can be illustrated by means of modeling fluid flow around the MIP fibers using a model based on Darcy's Law for membranes to find a unique and counter-intuitive solution that enables selected fiber-based MIP polymers to effectively perform even under extremely low (essentially no applied external pressure), yet retain the property of being able to effectively adsorb significant quantities (milligrams and higher) of a target molecule from a fluid unit volume without occupying and/or displacing a significant amount of the fluid to be treated.

Under Darcy's Law, the pressure drop experienced by a fluid flowing through a compact membrane or web of fibers (fabric) or a packed bead of beads, is given by the following Equation 1:

ΔP=(1/B)·μ·t·(V/100) Eq. 1

wherein ΔP is the fluid pressure drop across a fabric in units of pounds per square inch (psi) and having a conversion factor equal to [(1/psi)×6.895E4 g/(cm-sec2)], B is the permeability in cm2; μ (mu) is the fluid dynamic viscosity in centipoise (cP), having a conversion factor equal to [10-2×gram/(cm-sec)] and for water being a value nominally around about 0.01 g/cm-sec (1.0 centipoise); t is the web thickness, commonly called “loft” in the trade and having units of centimeters (cm); and V is the velocity of fluid as it approaches the fiber web from one side, having units of cm/sec.

Darcy's Law is only valid for fluid conditions where there is laminar flow; i.e. where the Reynolds No. (Re) is less than about 10. Fortunately for many applications of the present disclosure, laminar flow is a desired, although not essential condition, generally being preferred owing to the better ease of predicting and designing equipment that utilize laminar flow methods when processing a fluid. For example, with regards to V, if one considers a human stirring a spoon or a MIPs polymer extraction of apparatus significantly in the shape and size of a spoon in a cup of coffee, a velocity of about 25 cm/sec (about 1 foot/second) seems a reasonable estimate as a minimum flow rate for the systems of interest, as an example of use of a hand held apparatus employing the invention, and representing a lamellar flow condition.

To calculate a membrane or web permeability value however may require application of MacGregor's relationship, which employ's Kozeny's unitless constant (See “Engineering Applications of Computational Fluid Mechanics”, Vol. 8, No. 2, pages 308-318 (2014), authored by Ozgumus, et al., and hereby incorporated in its entirety by reference) that accounts for the effect on permeability, B, which is found to depend dramatically on changes in cross section area of the fibers despite the fact that the porosity, or total area exposed to fluid flow, remains invariant with respect to changes in fiber diameter.

One way to visualize this effect is to refer to the illustration below, which shows two unit (the same) cross-sectional areas having the same open space area for fluid flow perpendicularly through the plane of the illustrations, the dark areas being solid, here representing the collection of fiber cross-sectional areas within a unit area; and the light areas being openings (pores) between said fibers.

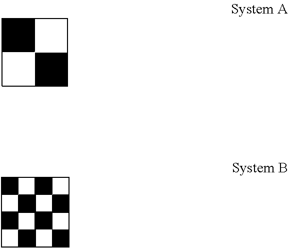

Intuitively, one can see that System B, despite having the same cross-sectional open surface area (porosity) available for flow as System A, will offer more resistance to flow than the corresponding System A owing to the smaller pore size through which the fluid would have to flow. Thus, it is necessary to account for the effect of fiber size on permeability, rather than porosity, as the former properly accounts for the effect of cross-sectional fiber size on fluid flow.

Accordingly, the inventors apply MacGregor's equation below:

B=(d²/16Kₒ)·(Φ³/(1−Φ)² Eq. 2

wherein B is the permeability factor described above; d is the fiber diameter in units of centimeter (cm); Kₒ is the Kozeny constant, nominally having a value of about 10 and being unit-less; and Φ (phi) is the porosity of the fiber bed, being a dimensionless number.

To determine the permeability parameter, porosity can be solved for using the relationship below (See “National Textile Center Annual Report” November 2000, Document No. M98-P02, whole document, authored by Matthew Dunn, hereby incorporated in its entirety by reference) which relates the physical equivalence between porosity and the “basis weight” of the fiber bed:

Φ=1−[Γ/(t·ρₛ)]·1×10⁻⁴ Eq. 3

wherein Γ (gamma) is the basis weight of the fiber bed, also known as “Areal” weight and having units of grams/meter2; t is the web thickness as above, in units of centimeter (cm); and ρₛ (rho sub s) is the density of the solid fiber polymer in units of g/cm3; the factor of 10,000 in the denominator being a conversion factor between square meters to square centimeters. Note that with Areal or basis weight, being a parameter having units expressed in weight per square unit area, that the more spacing between fibers lowers the basis weight, there being fewer fibers within the same unit area versus a more densely packed and higher basis weight fabric or web of fibers.

Correspondingly, for a packed bed of beads, the Kozeny-Carman equation rather than MacGregor's, is employed to determine B, the permeability factor of interest:

B=([1/Kₒ·Sₒ²)]·(Φ³/(1−Φ)² Eq. 4

wherein Kₒ is the Kozeny constant, already introduced herein; and Sₒ is the ratio of the surface area to the volume of a sphere or bead and is equivalent to 6/d, d being the diameter of the bead or sphere in units of centimeter (cm). In contrast to fibers, packed bead systems tend to form simpler geometrically constrained packed beds depending on uniformity of bead size and the packaging order, so that determination of porosity is somewhat simpler, being between about 26% for angular stacking of spheres (74% stacking efficiency as commonly seen in a stack of oranges at the corner grocery store) and about 48% for vertical stacking (only 52% stacking efficiency) which is seen more typically for larger spheres packed or held in a constrained fashion.

However, for both a MIP fiber or MIP bead system, a further critical characteristic required to achieve a significant level of removal of a target entity is to have a sufficiently high enough number of MIP sites on the surface of the polymer to bind them, and perhaps more critically, have nearly all the sites available to contact the fluid within a short enough period of time to effect timely (how long it takes to adsorb) as well as efficient (the fractional extent of all available target entities removed from the fluid by the MIP polymer). Thus, there must be a trade-off between having sufficient permeability of the fiber bed and selection of a MIP polymer fiber size that has sufficient numbers of MIP binding sites present.

To determine an effective operating range for particle MIPs and fiber MIPs, the additional relationships shown in Table 1 are employed to account for the MIP surface site density, total fabric surface and efficiency factor.

TABLE 1
Conversion Factors & Equations Used in Calculations

| System | Conversion Factors & Equations |
|---|---|
| Packed | ρ_{MIP} = MIP site density, units of # of MIP sites/cm³ |
| Fiber Bed | A_{MIP} = Area occupied by single theoretical site, cm² |
| | A_{f} = Surface provided by 1 cm³ of fabric |
| | 1 cm³ fabric = (Γ · 10⁻⁴)/t |
| | A_{f} = (4 × 10⁻⁴ · Γ)/(t · d · ρₛ) |
| | ρMIP = A_{f}/A_{MIP} |
| | Fₐᵣ = Fiber aspect ratio factor, being the relative effective unit |
| | cylindrical surface area-to-fiber cross-sectional area(Note 1) |
| Packed | ρ_{MIP} = MIP site density, units of # of MIP sites/cm³ |
| Bead Bed | A_{MIP} = Area occupied by single theoretical site, cm² |
| | A_{b} = Surface provided by 1 cm³ of bead packing |
| | A_{b} = 6 · (1 − Φ)/(d) |
| | 1 cm³ packing = (1 − Φ) · 1 cm³ |
| | ρ_{MIP} = A_{b}/A_{MIP} |
| Common | MW = molecular weight of target imprintable entity(Note 2) |
| Factors | F_{MIP} = Extraction efficiency factor, being the number of target |
| | entities bound per effective MIP site(Note 3) |
| | A_{MIP} = 1.0 × 10⁻¹⁴ cm², about 1 nm² |
| | ρₛ = about 1.1 g/cm³ |
| | μ = 1.0 cP. This will be converted from units of centipoise to |
| | g/cm-sec for calculations |

Notes:
(1)As discussed herein, shaped or lobed fibers provide significantly enhanced surface areas versus a round circular fiber of the same cross sectional surface area, or basis weight. Numerically defined as 1.0 for a perfectly circular cross-sectional (round) fiber aspect ratio.
(2)For biologics, the molecular weight in Daltons is employed, for other species an atomic weight or molecular weight in units of grams/mole is employed.
(3)Based on the work of Jin, et al. (See J. Ind. Eng. Chem. Vol. 12, No. 3, pages 494-499 (2006), authored by Yinzhe Jin and Kyung Ho Row, and hereby incorporated herein in its entirety by reference), an experimentally derived value for caffeine can be estimated to be about 400, which is adopted here as a scaling factor and which likely depends on experiment conditions used in forming the MIP polymers, and can be changed accordingly as required for any particular system of interest.

Using the above equations and conversion factors in Table 1 then enables the calculation of pressure loss as a function of several MIP bead and/or MIP fiber parameters in order to determine the best configuration for creating an effective extraction apparatus.

The following examples represent embodiments of applications for an apparatus constructed of MIP polymer fibers to extract caffeine from coffee under conditions of (1) an inventive apparatus designed for hand operation by a person intended for single-usage to decaffeinate a typical cup of coffee by manual stirring; (2) an inventive apparatus designed in the form and approximate size of a typical coffee filter for single-usage to decaffeinate a stream of coffee automatically during brewing through a filter; and (3) an inventive apparatus designed for renewable industrial usage to decaffeinate a stream of coffee in-line where significant pressure can be applied to the fluid to assist in speeding the extraction process and efficiency.

These example embodiments are for illustration purposes only and the choice to employ caffeine and MIP polymers imprinted to target caffeine are selected here solely by way of example. The same inventive approach, accounting for differences of target imprintable entity (TIE) size (and/or entity molecular weight); binding efficacy (FMIP)of the targeted entity; and fluid type, can be applied to any selected suitable entity, and the methods of extraction and recovery using MIP polymer fibers, and/or an apparatus employing the MIP polymer fibers; and further, the methods of using said MIP polymer fibers and/or webs constructed thereof and/or an apparatus constructed thereof to extract/recover target entities from a fluid can be universally applied to any desired TIE in any desired fluid compatible with the MIP polymer fiber material employed.

For example, but not limited to these specific target entities, other embodiments of the invention selected for treating a quantity of fluid to remove an undesired material include a device and use of said device employing MIP polymers as described herein to remove a drug, a toxin, an allergen, a chemical and/or a contaminant selected from any one of the example embodiments presented herein, from a fluid such as a liquid, a glass of water, a beverage, an alcoholic beverage, a liquid food product or extract, and the like.

### MIP Fiber Webs—Low Pressure Applications

Exploring a first general embodiment of the invention as introduced above regarding use of a plurality of MIP polymer fibers or a web of MIP polymer fibers incorporated into an apparatus or device specifically tailored to remove a significant quantity of a TIE from a fluid solution, an example of extracting a significant quantity of caffeine from a volume of fluid (coffee) under near static (i.e. gentle stirring conditions under submersion) conditions is now considered.

In one embodiment of the present invention is a device approximately in the shape of a spoon or wand composed of a packed web of MIP polymer fibers, optionally formed into, or yet alternatively contained within a secondary means, such as a porous cylinder, for example. As discussed above, if one considers a human stirring such an extraction device in a cup of fluid, a velocity of about 25 cm/sec (about 1 foot/second) seems a reasonable estimate as a minimum flow rate that the device would experience during manual use. Again, while the following examples explore embodiments of the invention relating to caffeine extraction, it should be noted that the general approach is applicable for similar removal of other selected TIEs from any fluid compatible with the MIP polymer materials, and/or fibers and/or webs formed thereof.

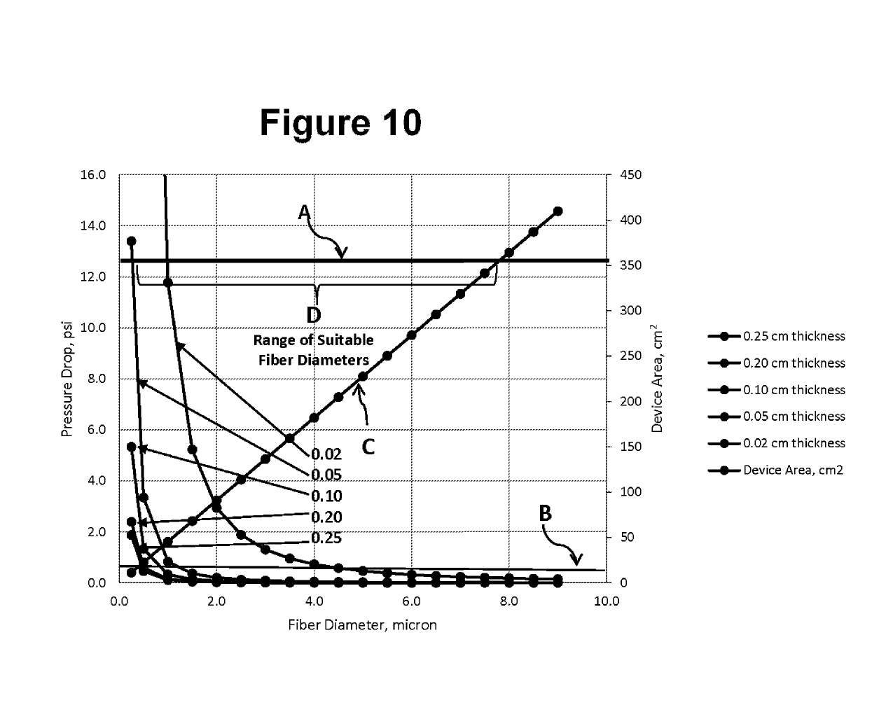

Now, exploring a MIP polymer fiber approach, one may use the parameters in Table 1 along with a target extraction of 160 mg of caffeine to be removed from an eight ounce (8 oz) cup of coffee, a molecular weight (MW) for caffeine of 194 g/mol, using a MIP polymer fiber web having a Areal weight of 75 g/m2, to calculate the properties of several inventive embodiments of systems display the properties shown in FIG. 10.

In FIG. 10, the right secondary Y-axis shows the geometrical surface area of a MIP fiber device with the upper horizontal line denoted “A” selected as a reasonable maximum limit, being the surface area of a typical number 4 coffee filter (A4) and corresponding to approximately 340 cm2, plotted against the MIP fiber diameter in microns as the X-axis; and simultaneously showing the calculated pressure drop (in psi) on the left (primary) Y-axis. The lower horizontal line denoted “B” represents the approximately maximum desired 0.3 psi pressure drop selected as a reasonable limit for a device employing the inventive MIP fiber web to operate under low fluid velocity manual stirring conditions, this pressure drop value being somewhat approximate, corresponding to the pressure differential between the surface of a fluid (top) and its base (bottom) having a depth of about 10 cm (100 millimeters), thus exhibiting a pressure head equivalent of about 0.15 psi, after converting from 760 mm of Hg (mercury) at an average sea-level atmospheric pressure of 14.7 psi, using the relationship of 100 mm H2O equivalent to about 7.36 mm Hg and a solution density of about 1.1 g/cm3. This is then multiplied by 2 to account for mechanical stirring action, providing the approximately maximum desired 0.3 psi pressure drop value used herein. In addition, the line denoted “C” illustrates the calculated surface area of the device, intersecting with line “A” at the maximum desired surface area limit of 340 cm2. Further, the bracket denoted “D” illustrates the range of suitable fiber diameters providing sufficient surface area below the maximum desired device surface area represented by line “A”.

It is clearly noted however that not all fiber diameters are useful under the constraints selected for this particular embodiment due to the excessive (greater than about 0.3 psi) pressure drop they impose on the system. Referring to Table 2, only example embodiments 1-3 exhibit properties that would enable practical usage under the desired conditions. Example embodiment 1 has a fiber size of 6.0 microns, requires less “device” surface area than the maximum limit, but imposes a pressure drop of 0.327 psi, slightly exceeding the target value of about 0.3 psi, and thus represents an approximately lower fiber size limit that would be suitable for a 0.02 cm thick fiber web. In contrast, example embodiment 4 with a fiber size of 8.0 microns, has an acceptable pressure drop of 0.184 psi, but requires about 364 cm2 of geometrical “device” surface area, which is just slightly about the upper desired surface area target of 340 cm2 optionally selected to keep the device size suitable for use, but would likely be acceptable within experimental error (+10%) particularly as it offers some further advantage with its reduced pressure drop compared to example embodiment 3.

The other examples in Table 2, A1-I1, however, would not be suitable for this particular use, either imposing too high a pressure drop, or conversely requiring a significant excess of additional surface area (i.e. device size) to function to be capable of essentially removing the entire amount and/or a significant fraction of the caffeine desired.

TABLE 2
Pressure Drop for Various Sized MIP Polymer Fibers in 0.02 cm
thick fiber web (Note 1):

| | | | | | MIP |
|---|---|---|---|---|---|
| | | | | Pressure | Density |
| | d | Web Area | Permeability | Drop | (#/cm³ of |
| Example | (microns) | (cm²) | (cm²) | (psi) | fabric) |
| A1 | 0.25 | 11.384 | 9.623E−12 | 188.39 | 4.364E+17 |
| B1 | 0.5 | 22.767 | 3.849E−11 | 47.10 | 2.182E+17 |
| C1 | 1.0 | 45.535 | 1.540E−10 | 11.77 | 1.091E+17 |
| D1 | 2.0 | 91.069 | 6.159E−10 | 2.940 | 5.455E+16 |
| E1 | 3.0 | 136.604 | 1.386E−09 | 1.308 | 3.636E+16 |
| F1 | 4.0 | 182.139 | 2.464E−09 | 0.736 | 2.727E+16 |
| G1 | 5.0 | 227.674 | 3.849E−09 | 0.471 | 2.182E+16 |
| 1 | 6.0 | 273.208 | 5.543E−09 | 0.327 | 1.818E+16 |
| 2 | 6.5 | 295.976 | 6.505E−09 | 0.279 | 1.678E+16 |
| 3 | 7.0 | 318.743 | 7.545E−09 | 0.240 | 1.558E+16 |
| 4 | 8.0 | 364.278 | 9.945E−09 | 0.184 | 1.364E+16 |
| I1 | 9.0 | 409.812 | 1.247E−08 | 0.145 | 1.212E+16 |

Notes:
(1) Other parameters held constant include: V, fluid velocity at 25 cm/sec; Γ, Ariel (loft) being 75 g/cm²; ρₛ = 1.1 g/cm²; Kₒ, Kozeny constant, 10; MW = molecular weight of caffeine, 194 g/mol; F_{MIP}, extraction efficiency factor, 400; and A_{MIP}, area of average MIP binding site on the polymer fiber surface, 1.0E−14 cm². Here, t, thickness of fiber web, 0.02 cm. Note that conditions of laminar flow are assumed; other parameters as indicated in the table above or in Table 1.

However, the efficiency of the MIP fiber device can be improved by increasing the thickness of the fiber web. Table 3 shows the pressure drop for various sized MIP polymer fibers in a 0.10 cm thick fiber web (example embodiments 5-10). Here, it is seen that example embodiments 5-10 all roughly meet the requirements of sufficient geometric surface area while not imposing an excessive pressure drop exceeding about 0.3 psi, and thus would be expected to function as desired under the limiting circumstances, although here Example C3 is just on the border line with respect to the total geometric surface area needed.

Accordingly, examples A3, B3, D3 and E3 would not function, either imposing two high a pressure drop, or not having sufficient surface area to effect the desired level of caffeine removal, example C3 being borderline with respect to the required surface area required, but not however offering much advantage versus Example 10 with respect to a further reduced pressure drop parameter.

TABLE 3
Pressure Drop for Various Sized MIP Polymer Fibers in 0.10 cm
thick fiber web (Note 1):

| | | | | | MIP |
|---|---|---|---|---|---|
| | | | | Pressure | Density |
| | d | Web Area | Permeability | Drop | (#/cm³ of |
| Example | (microns) | (cm²) | (cm²) | (psi) | fabric) |
| A3 | 0.25 | 11.384 | 6.799E−10 | 5.333 | 4.364E+17 |
| B3 | 0.50 | 22.767 | 2.719E−09 | 1.333 | 2.182E+17 |
| 5 | 1.0 | 45.535 | 1.088E−08 | 0.333 | 1.091E+17 |
| 6 | 1.5 | 68.302 | 2.447E−08 | 0.148 | 7.273E+16 |
| 7 | 2.0 | 91.069 | 4.351E−08 | 0.083 | 5.455E+16 |
| 8 | 4.0 | 182.139 | 1.740E−07 | 0.021 | 2.727E+16 |
| 9 | 6.0 | 273.208 | 3.916E−07 | 0.009 | 1.818E+16 |
| 10 | 7.0 | 318.743 | 5.330E−07 | 0.007 | 1.558E+16 |
| C3 | 8.0 | 364.278 | 6.962E−07 | 0.005 | 1.364E+16 |
| D3 | 8.5 | 387.045 | 7.859E−07 | 0.005 | 1.283E+16 |
| E3 | 9.0 | 409.812 | 8.811E−07 | 0.004 | 1.212E+16 |

Notes:
(1) Same factors held constant as per Table 2, except t, thickness being 0.10 cm; other parameters as indicated in the table above or in Table 1.

Exploring the effect of fiber web thickness, Table 4 presents calculated values for pressure drops for various sized MIP polymer fibers in a web of 0.25 cm thickness (example embodiments 11-17). Here, it is noted that a much wider range of fiber diameters are suitable to achieve the particular device requirements required, including fibers from about 1.0 micron to about 7.5 microns in diameter. For instance, examples embodiments 11-17 all show an acceptable geometric surface area and all fall below the approximately 0.3 psi pressure drop limit desired for a stirring-based extraction device employing the inventive MIP polymer fibers in the form of a compact fiber web.

Example A4 in contrast, while having a very favorable low geometrical surface area, would require too high a pressure drop of about 0.47 psi to ensure effective flow through a device constructed using these fibers and parameters. Also, examples B4, C4 and D4 are not particularly suitable, despite having acceptable pressure drops, owing to the excessive amount of additional MIPs fiber material that would be required to provide their larger geometric surface areas needed in a device. Here, a fiber size of 8.0 microns (Example B4) is again borderline with respect to desired design parameters, but offers no significant advantage with respect to reduced pressure drop versus Example 17, both calculated to induce about a 0.002 psi pressure drop across the fiber web in use.

TABLE 4
Pressure Drop for Various Sized MIP Polymer Fibers in 0.25 cm
thick fiber web (Note 1):

| | | | | | MIP |
|---|---|---|---|---|---|
| | | | | Pressure | Density |
| | d | Web Area | Permeability | Drop | (#/cm³ of |
| Example | (microns) | (cm²) | (cm²) | (psi) | fabric) |
| A4 | 0.50 | 22.767 | 1.933E−08 | 0.469 | 2.182E+17 |
| 11 | 1.0 | 45.535 | 7.734E−08 | 0.117 | 1.091E+17 |
| 12 | 1.5 | 68.302 | 1.740E−07 | 0.052 | 7.273E+16 |
| 13 | 2.0 | 91.069 | 3.094E−07 | 0.029 | 5.455E+16 |
| 14 | 4.0 | 182.139 | 1.237E−06 | 0.007 | 2.727E+16 |
| 15 | 6.0 | 273.208 | 2.784E−06 | 0.003 | 1.818E+16 |
| 16 | 7.0 | 318.743 | 3.790E−06 | 0.002 | 1.558E+16 |
| 17 | 7.5 | 341.510 | 4.350E−06 | 0.002 | 1.455E+16 |
| B4 | 8.0 | 364.278 | 4.950E−06 | 0.002 | 1.364E+16 |
| C4 | 8.5 | 387.045 | 5.588E−06 | 0.002 | 1.283E+16 |
| D4 | 9.0 | 409.812 | 6.264E−06 | 0.001 | 1.212E+16 |

Notes
(1) Same factors held constant as per Table 2, except t, thickness being 0.25 cm; other parameters as indicated in the table above or in Table 1.

It is to be noted that the chosen fiber diameters, thickness and loft of MIP fibers of the preceding examples represent embodiments selected to achieve a device conforming to the desired parameters, these parameters could change or be modified to construct a device with any range of functional parameters desired that are within the scope of the present invention for any desired fluid and target entity capable of being imprinted on a MIP polymer.

Next, the effect of loft or the Ariel parameter on the MIP fiber method and an apparatus employing the fibers is explored in Table 5, showing example embodiments 18 to 29.

TABLE 5
Pressure Drop for Various Sized MIP Polymer Fibers in 0.10 cm
thick fiber web, with Areal of 100 g/m2 (Note 1):

| | | | | | MIP |
|---|---|---|---|---|---|
| | | | | Pressure | Density |
| | d | Web Area | Permeability | Drop | (#/cm³ of |
| Example | (microns) | (cm²) | (cm²) | (psi) | fabric) |
| A5 | 0.50 | 17.076 | 1.057E−08 | 0.857 | 2.909E+17 |
| 18 | 1.0 | 34.151 | 4.229E−08 | 0.214 | 1.455E+17 |
| 19 | 1.5 | 51.227 | 9.516E−08 | 0.095 | 9.697E+16 |
| 20 | 2.0 | 68.302 | 1.692E−07 | 0.054 | 7.273E+16 |
| 21 | 3.0 | 102.453 | 3.807E−07 | 0.024 | 4.848E+16 |
| 22 | 4.0 | 136.604 | 6.767E−07 | 0.013 | 3.636E+16 |
| 23 | 5.0 | 170.755 | 1.057E−06 | 0.009 | 2.909E+16 |
| 24 | 6.0 | 204.906 | 1.523E−06 | 0.006 | 2.424E+16 |
| 25 | 7.0 | 239.057 | 2.072E−06 | 0.004 | 2.078E+16 |
| 26 | 8.0 | 273.208 | 2.707E−06 | 0.003 | 1.818E+16 |
| 27 | 9.0 | 307.359 | 3.426E−06 | 0.003 | 1.616E+16 |
| 28 | 9.5 | 324.435 | 3.817E−06 | 0.002 | 1.531E+16 |
| 29 | 10.0 | 341.510 | 4.229E−06 | 0.002 | 1.455E+16 |
| B5 | 10.5 | 358.586 | 4.663E−06 | 0.002 | 1.385E+16 |
| C5 | 11.0 | 375.661 | 5.118E−06 | 0.002 | 1.322E+16 |
| D5 | 12.0 | 409.812 | 6.090E−06 | 0.001 | 1.212E+16 |

Notes
(1) Same factors held constant as per Table 2, except t is 0.10 cm, and Γ, Ariel (loft) being 100 g/m²; other parameters as indicated in the table above or in Table 1.

The results in Table 5 (example embodiments 30-44) can be contrasted to those shown in Table 3, where at any particular selected fiber diameter, the differences noted are due to changing the Areal or loft of the MIP polymer fiber web from about 40 g/m2 to about 100 g/m2 as shown in Table 5. It is noted that with the higher loft value, a wider range of fiber diameters, represented by embodiment examples 18-29, are found suitable to achieve the particular device requirements required here for a manually operated embodiment, spanning fiber diameters from about 1.0 micron to about 8.0 micron. Table 5 also shows the ultimate tunability of the present inventive approach in enabling precise selection of the device parameters, as illustrated by comparing the pressure drop for fibers having 0.50, 1.0 and 1.5 micron diameters, exhibited an ultimate web pressure drop of 0.857 psi, 0.214 psi and 0.095 psi, respectively.

Thus, fine changes in fiber diameter can be selected to precisely tune and/or optimize the resulting inventive apparatus to function with respect to any desired pressure drop, while still providing sufficient surface area of available MIP polymer binding sites to achieve the desired level, here significantly complete removal of the target entity. Further, fiber size may be selected that will enable the resulting MIP polymer fiber web to work with little or no pressure drop at all, as shown by example embodiments 26-29, which all exhibit pressure drops of an order of magnitude (10 fold) less than the maximum 0.3 psi value selected. Indeed, although these referenced embodiments have extremely low pressure drops, they all can achieve the desired target entity extraction owing to having total geometric surface “device” areas within (below or significantly equivalent to within experimental error) the desired 340 cm2 limit selected.

Now comparing the effect of Areal as web thickness is varied while maintaining a constant overall web area, Table 6 shows the fiber size (in microns) required and the corresponding pressure drop across the web. In example embodiments 30 to 34, a fiber diameter of 4.0 microns in a web having an Areal of 40 g/cm2 provides a total geometric web area of approximately 340 cm2. Further, the web volume, or total size displacement of the exampled fiber web is shown, enabling an estimate of the minimum volume or size of an inventive device employing the MIP polymer fiber web needed to adsorb significantly all the target entity, here exampled being defining MIP polymer and fiber parameters for a device capable of removing 160 mg of caffeine from a fluid having a volume of about 8 ounces (236.6 mL).

TABLE 6
Pressure Drop and Overall Web Volume of Fiber Webs of Various
Areal Loft as Web Thickness is Varied (Note 1):

| | | | t, web | | |
|---|---|---|---|---|---|
| | Γ, Ariel | D | thickness | Web Volume | Pressure |
| Example | (g/cm²) | (microns) | (cm) | (cm³) | Drop (psi) |
| 30 | 40 | 4.0 | 0.02 | 6.83 | 0.109 |
| 31 | 40 | 4.0 | 0.05 | 17.1 | 0.012 |
| 32 | 40 | 4.0 | 0.10 | 34.2 | 0.005 |
| 33 | 40 | 4.0 | 0.20 | 68.3 | 0.003 |
| 34 | 40 | 4.0 | 0.25 | 85.4 | 0.002 |
| 35 | 75 | 7.5 | 0.02 | 6.83 | 0.209 |
| 36 | 75 | 7.5 | 0.05 | 17.1 | 0.015 |
| 37 | 75 | 7.5 | 0.10 | 34.2 | 0.006 |
| 38 | 75 | 7.5 | 0.20 | 68.3 | 0.003 |
| 39 | 75 | 7.5 | 0.25 | 85.4 | 0.002 |
| 40 | 100 | 10.0 | 0.02 | 6.83 | 0.396 |
| 41 | 100 | 10.0 | 0.05 | 17.1 | 0.018 |
| 42 | 100 | 10.0 | 0.10 | 34.2 | 0.006 |
| 43 | 100 | 10.0 | 0.20 | 68.3 | 0.003 |
| 44 | 100 | 10.0 | 0.25 | 85.4 | 0.002 |

Notes:
(1) Fiber diameter selected to nearest ±0.5 micron diameter required to produce a fiber web, at selected Areal loft, having a total geometrical surface area of approximately 340 g/cm² (±1 g/cm²); other parameters as indicated in the table above or in Table 1.

In Table 6, example embodiments 30 through 44 illustrate how the MIP polymer fiber web thickness, t, can be selected at a particular Areal value to have sufficient geometrical surface area (about 340 g/cm2) and yet not impose greater than around a 0.3 psi pressure drop. It is noted that higher Areal values are proportionally related to the fiber diameters, roughly following a 10: 1 ratio in values with respect to the ratio of the Areal value (in units of g/cm2) to fiber diameter (in units of microns), suggesting a rough rule-of-thumb linear scaling law that can be applied to other embodiments of the instant inventive apparatus employing MIP polymer fibers in a condensed fiber web construct to select a fiber diameter suitable to balance the need for the overall surface area required that is sufficient to adsorb the quantity of target entities, which necessitates a certain density of available MIP binding sites so as not to exceed some desired maximum pressure drop across the fiber web.

However, another important parameter with regard to using MIP polymer fibers in a construct and/or device and/or apparatus for treating a selected volume of fluid, is the total geometric volume that the polymer web occupies, as it will necessarily displace a roughly similar volume of the fluid (depending on the web porosity or fractional extent of “open” space).

In Table 6, the total geometric volume of the MIP polymer fiber web is also presented, showing a range of values for various selected fiber diameters of between about 6.83 cm3 to about 85.4 cm3. These values represent the minimum volumes that these particular example embodiments of the MIP polymer fiber web would occupy, absent any containment or support structure to hold the fiber web intact without distortion during an extraction process. As these embodiments are examples of fiber webs that would be suited for a manual removal process, the size is an important factor, particularly for a commercialized product that is intended to be for use by a person to treat a typical cup of coffee, or other similar beverage or liquid to remove the target entity. A typical cup size of 8 U.S. fluid ounces has a total fluid volume of about 236.6 cm3. By way of comparison, a box of C&H brand sugar cubes contains 252 cubes having a combined net weight of 2.0 lbs (pounds) or about 907 grams. Each cube is approximately 1.5 cm on a side, thus having a cubic volume equivalent to (1.5 cm)3 or 3.375 cm3. The cubes have an average approximate density corresponding to the total weight divided by the total volume of sugar, being equivalent to [907 g/(252×3.375 cm3)] or about 1.07 g/cm3. Accordingly, for a MIP polymer fiber device according to example embodiment 30, the polymer web would require a volume equivalent to about 2 sugar cubes (6.83 cm3/3.375 cm3), while example embodiment (85.4 cm3/3.375 cm3) would require a volume equivalent to about 25 sugar cubes. This latter volume is fairly large compared to the volume of the typical 8 ounce cup mentioned hereinabove, occupying about 36% (100% ×85.4 cm3/236.6 cm3) of the volume and therefore displacing some proportional amount of the fluid, possibly resulting in overflow from the container.

Hence, while all example embodiments would be suitable for use, those capable of being rendered into smaller and more compact apparatus with volumes that are fractional (less than about 25%) with respect to the volume of fluid are likely more preferred in a manual treatment method achieved by means of submersion of the inventive MIP polymer fiber webs in the fluid to be treated.

Alternatively, a shape of a cylinder in the form of a stir stick is another potential shape. A cylinder (rod) has a volume equal to πr2h, where r is the radius and h is the height or length of the cylinder. Thus, for a 1.5 cm diameter rod (r=0.75 cm), the approximate length (height) of a MIP polymer fiber web device in the form of a uniform rod would be equal to V/π(0.75)2, or 3.9 cm for example embodiment 30, and 9.7 cm for example embodiment 31.

Thus, either of these embodiments would be suitably employed for a rod-shaped wand for extracting caffeine from a cup of coffee with all the required properties necessary and being sized dimensionally within a range suitable for use in stirring the fluid without splashing or significant volume displacement.

In another series of embodiments, the typical round (circular) cross-sectional MIP polymer fibers can be replaced using lobed fibers, produced by an extrusion process using an orifice that forms deep grooves in the fiber cross section, or by the use of a core-sheath bicomponent (two different polymers) fiber, or by other fibers offering enhanced surface areas compared to round fibers, as described herein in the MIP Polymer Fiber Morphology section

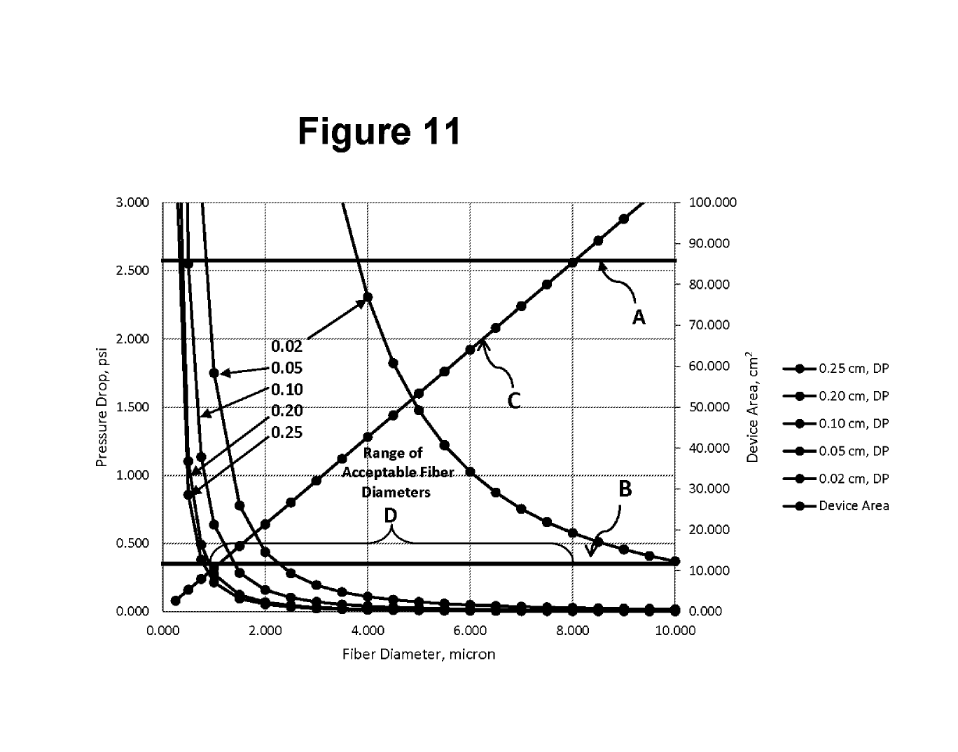

Using the example of Fiber Innovation Technology's 4DG™ Deep-Grooved Fiber technology, a surface area amplification factor of 4 with respect to the increased number of available MIP polymer binding sites present versus a solid round (circular) cross-section fiber enables a generally smaller amount of MIP polymer material to be used. In FIG. 11, one advantage is seen in that the total geometric surface area of a device employing the MIP polymer fiber is thus reduced accordingly by that factor of 4, requiring only 85 cm2 versus 340 cm2 of fiber web material to be used in an extraction process and/or device. Using the 4DG™ Deep-Grooved Fiber process to form MIP polymer fibers assembled into a fiber web or device according to the present invention would enable less overall MIP polymer to be employed, reducing the size of a stirring device employing the MIP polymer fiber webs as discussed hereinabove.

In FIG. 11, it is seen that a wide range of fiber diameters fall within a range of acceptable fiber diameters as indicated by the bracket denoted “D”, the acceptable fiber diameters providing on one hand sufficient total geometric surface area to provide a sufficient number of MIP binding sites, while on the other hand not inducing greater than about a 0.3 psi pressure drop as selected for a hand held stirring device for the extraction of a target entity from a fluid.

Table 7 shows additional embodiments (45-55) of the inventive approach using fibers with various surface area enhanced morphologies. For these calculations, it was assumed that the surface morphologies of the fibers do not significantly alter the permeability of fiber webs constructed of the surface modified fibers because the scale of the surface variations do not exceed the dimensionality of the average fiber diameter cross-section, so the net realized effect is primarily to magnify the total available surface area available for fluid contact without changing the average fiber-to-fiber spacing on which the overall web permeability parameter most critically depends.

Thus, to a first approximation, no significant increase in pressure drop is anticipated due to fiber surface morphology, although the inventive model can easily be modified to include a correction factor should experimental results differ significantly to warrant a refinement in the model.

TABLE 7
Pressure Drop and Overall Web Volume of Fiber Webs
employing Surface Area Enhanced Fibers with Various
Amplification Factors (Note 1):

| | | | Surface | | | |
|---|---|---|---|---|---|---|
| | | | Area | | | |
| | | | Ampli- | | | |
| | | | fication | | | |
| | d_{Avg} | t, web | Factor | Web | Web | Pressure |
| Exam- | (microns) | thickness | (unitless) | Area | Volume | Drop |
| ple | (Note 2) | (cm) | (Note 3) | (cm²) | (cm³) | (psi) |
| A7 | 11.0 | 0.02 | 1.0 | 469.6 | 9.39 | 0.305 |
| 45 | 11.0 | 0.02 | 2.0 | 234.8 | 4.70 | 0.305 |
| 46 | 11.0 | 0.02 | 3.0 | 156.5 | 3.13 | 0.305 |
| 47 | 11.0 | 0.02 | 4.0 | 117.4 | 2.35 | 0.305 |
| 48 | 2.5 | 0.10 | 1.0 | 106.7 | 10.67 | 0.102 |
| 49 | 2.5 | 0.10 | 2.0 | 53.4 | 5.34 | 0.102 |
| 50 | 2.5 | 0.10 | 3.0 | 35.6 | 3.56 | 0.102 |
| 51 | 2.5 | 0.10 | 4.0 | 26.68 | 2.67 | 0.102 |
| 52 | 1.5 | 0.25 | 1.0 | 64.03 | 16.01 | 0.095 |
| 53 | 1.5 | 0.25 | 2.0 | 32.02 | 8.04 | 0.095 |
| 54 | 1.5 | 0.25 | 3.0 | 21.34 | 5.34 | 0.095 |
| 55 | 1.5 | 0.25 | 4.0 | 16.01 | 4.00 | 0.095 |

Notes:
(1) Calculations for a fiber web having an Areal or loft of 100 g/cm².
(2) Average cross-sectional diameter, for round fiber this value is equivalent to the nominal fiber diameter while for convoluted or lobed fibers this corresponds to the average cross-sectional diameter having essentially the same cross-sectional area as a corresponding round fiber of similar diameter.
(3) Amplification factors: 1.0 = unmodified round fiber; 2.0 = fiber with moderately lobed surface; 3.0 = fiber with significantly lobed surface; 4.0 = fiber with highly lobed surface. This factor effectively multiplies the available surface area of the unit (unmodified round) fiber.
(4) Other parameters as indicated in the table above or in Table 1.

Referring now to Table 7, it can be seen that in example A7, a fiber having a diameter of 11.0 microns, while having sufficient MIP binding sites to accommodate the level of caffeine adsorption as discussed above, nevertheless requires too high of a fiber web surface area (about 470 cm2) or conversely too large a physical volume (about 9.4 cm3), to be constructed or formed into either a filter device or a stirring device, respectively, even though the fiber web would otherwise meet the requisite pressure drop of at or below about 0.3 psi.

However, by employing surface modified and/or lobed fibers, which offer a surface area amplification factor greater than 1.0 (typical round fiber), inventive embodiment examples 45, 46 and 47 can be fabricated using a web thickness of 0.02 cm that is characterized as having the same pressure drop but which offers reduced total fiber web areas of 234.8 cm2, 156.5 cm2 and 117.4 cm2, respectively. These three preceding embodiments are examples of MIP polymer fibers that would be suitable for use in constructing an inventive device in the form of a coffee filter to extract caffeine during a brewing process. Further, these three embodiments are also examples of inventive MIP polymer fiber webs that could be shaped, formed into or contained within a device resembling a spoon or stir rod occupying a reasonable volume of between 4.70 cm3 and 2.35 cm3, being roughly on the order of the size of a typical sugar cube (3.4 cm3) and thus perfectly acceptable for manual use without concern for significant volume displacement of the fluid to be treated.

Inventive embodiments 48-51 represent examples of MIP polymer fibers of 2.5 micron diameter that are all suitable for use as a filtering device having a web thickness of 0.10 cm, offering a very favorable 0.102 psi pressure drop, and also having a total web area less than the 340 cm2 of a typical A4 coffee filter. Further, these four embodiments are also examples of inventive MIP polymer fiber webs that could be shaped, formed into or contained within a device resembling a spoon or stir rod occupying a reasonable volume of between 10.67 cm3 and 2.67 cm3, being roughly on the order of the size of about three sugar cubes for inventive embodiment 48 and about the size of a sugar cube for inventive embodiment 50.

Inventive embodiments 52-55 illustrate examples of MIP polymer fibers of 1.5 micron diameter that are all suitable for use as a filtering device having a web thickness of 0.25 cm, which offers a similar pressure drop of about 0.10 psi but uses significantly less overall MIP polymer material than the preceding two sets of embodiments discussed immediately above. By employing the finer fibers, the overall amount of MIP polymer material required for a filter is significantly reduced to about 64 cm2 just by using round fibers, and greatly reduced to about 32 cm2 by employing a lobed or surface modified fiber having an effective surface area amplification factor of 2.0 (Example 53).

Thus, any one of these inventive embodiments would be suitable for use in a small filter appropriately sized for a coffee machine unable to accommodate a conventionally sized filter, such as those devices used to make espresso or similar concentrated coffee-based beverages. For example, a typical low cost espresso machine such as the Mr. Coffee Steam Espresso Machine, model #ECM 160, sold by Sunbeam Products, Inc., and distributed by Jarden Consumer Solutions, Boca Raton, Fla. 33431, has a filter sleeve insert (which holds the coffee grounds) with a size typical of most other available retail and commercial espresso machines, being about 2.0 inches in diameter and about 1.25 inches deep. Thus, the espresso filter sleeve can accommodate a round filter of 5.08 cm diameter (conversion factor being approximately 2.54 cm/inch) corresponding to a surface area of about 20.3 cm2.

Accordingly, examples 54 and 55 represent inventive embodiments that could suitably be used as a filter that would fit within the filter sleeve insert of a typical espresso machine capable of removing up to 240 mg of caffeine. Of course, other combinations of MIP polymer fiber diameters having alternative surface area amplification factors equal to between 1.0 to about 4.0 or greater could also be selected by choosing an appropriate web thickness for an inventive device using the MIP polymer fibers.

Further, for an espresso-style coffee machine, steam and water pressure are used to extract the beans, so that MIP polymer fiber webs having significantly higher pressure drops than selected for a static gravity filter (0.3 psi) could also be selected and incorporated into an extraction device having some upper pressure drop value that would not negatively interfere with the brewing process by creating too high of a back pressure or slowing down the time required for extraction.

In another embodiment tailored for use in a coffee machine, the MIP polymer fibers may be formed into a flat membrane or fabric, optionally with folds or pleats, in the shape and size of a typical coffee filter. In an embodiment employing the inventive MIP polymer fibers in the form of and used as a coffee filter in a typical table-top coffee brewing machine, the standing liquid, at least during the transient stage before passing through the filter and into a receiving vessel below, would have an average depth of about 5 cm (50 mm H2O) and would be elevated at least about an additional 15 cm (150 mm H2O) for a total fluid head of about 200 mm H2O, corresponding to a head pressure across the filter of roughly about 0.32 psi.

Thus, embodiments identified above having pressure drops of less than or equal to approximately 0.3 psi (+10%) would be suitable for use in an inventive extraction process involving use of a MIP polymer fiber web device used to stir a cup of coffee and/or alternatively suitable for an extraction process using the inventive MIP polymer fiber webs in the form of a device resembling a coffee filter and substituting a typical coffee filter for use in a filter/drip coffee machine during a brewing process in which the caffeine is extracted from the brewed coffee as it is filtered through the inventive device, driven simply by gravity.

Nevertheless, other geometries are possible for the inventive apparatus, including but not being limited to, an apparatus comprised of MIP polymer fibers in a web form fabricated in the shape of a cylinder, rod, square, cone, flat membrane, lining on the inside of a vessel, articulated membrane, sheet, layer on a supporting member, tube, sphere, donut, torus, mesh, sponge and/or other similar geometric shapes and forms, and further including the shape of spoon or other common household utensil typically employed for stirring a fluid.

### MIP Polymer Beads Under Low Pressure Applications

In this section, the use of MIP polymer fibers is compared to the use of non-inventive round MIP polymer beads disclosed in existing art for a comparative example involving a targeted extraction of 160 mg of caffeine under gravity driven conditions as explored above, using a similar pressure drop of 0.34 psi as a reasonable upper limit under these conditions that a bed of beads would experience, such as for example being used in a filter drip system to decaffeinate coffee during a brewing process.

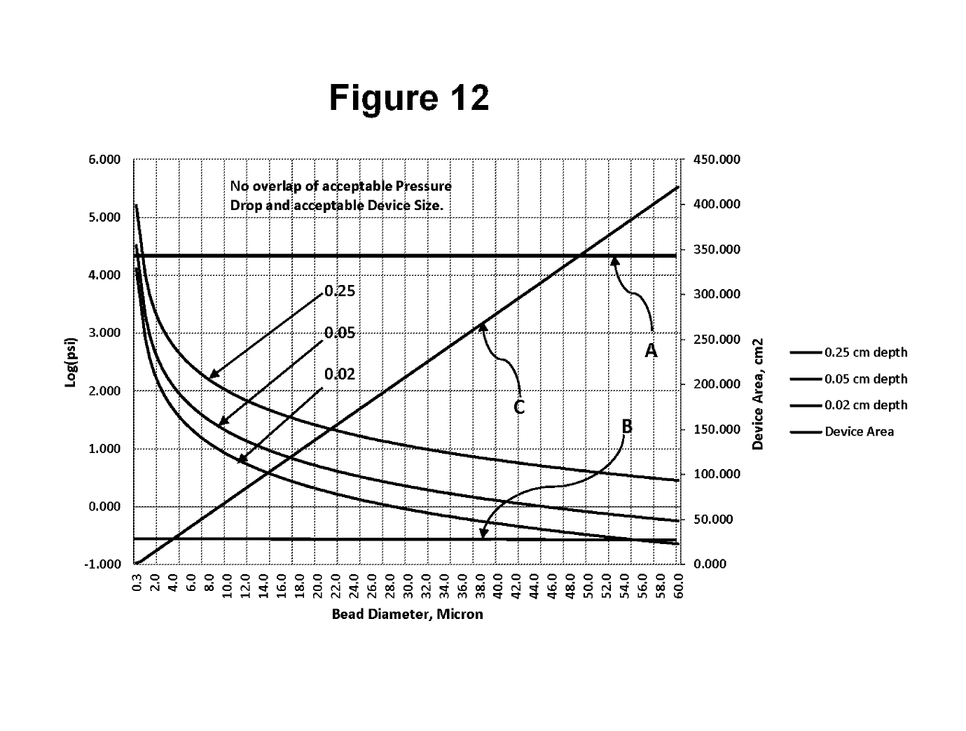

FIG. 12 shows the pressure drop (in units of log(psi), logarithmic units being chosen in order for the data to fit on the plot) versus bead diameter (microns) as function of various bed depths (cm) of the stacked beads. A face centered close (FCC) packing geometry (angular stacking) for the round beads is a reasonable assumption under usage conditions to minimize the overall volume of the system, because even if the beads where initially loosely packed in some containment means, such between two sheets of material to form a filter constructed so as to resemble and be fitted for use like the standard A4 coffee filter, subsequent fluid flow would result in the MIP particles moving and self-ordering into a more compact structure as fluid flows through the system and the beads aggregate. Thus, it is reasonable to assume that a FCC packing with an efficiency of 74% represents the likely stacking resulting, having a corresponding packing order (Φ) or 26%. In FIG. 12, the sloped line “C” indicates the device area (cm2) required to extract 160 mg of the TIE, here being caffeine, and the upper line labeled “A” represents a limited device area of 340 cm2 so as to compare the use of MIP polymer beads to the inventive MIP polymer fibers under similar circumstances of having the same overall area available for extraction. Further, in this same figure, line “B” represents the cutoff point corresponding to about a 0.34 psi pressure drop (log [0.34] is approximately -0.47). The three traces correspond to bead bed depths of 0.25 cm, 0.05 cm and 0.2 cm for bead diameters ranging between 0.3 micron to 60 micron, plotted against the corresponding pressure drop such beads would exhibit in each particular bed depth configuration.

It is readily noted that no overlap of acceptable pressure drop and bead diameters at any reasonable bead depth is capable of extracting the full 160 mg amount of the TIE desired, each configuration, while having sufficient available TIE binding sites to accommodate the full amount, nevertheless would exhibit too high a pressure drop in excess of 0.34 psi to function in as efficient and in a compact manner as the inventive MIP polymer fibers used under similar conditions.

Thus, although existing MIP polymer beads would likely extract some of the TIE, a significant fraction of the TIE present in the fluid would not be adsorbed due to the fluid being unable to effectively penetrate and flow through the packed bead system within a reasonable time to facilitate extraction, which requires fluid flow sufficient for the entire volume of the fluid to have an opportunity to pass through the extraction system. Further, even if the MIP polymer beads were not constrained in a packed structure as explored here in the comparative bead example, it is seen in FIG. 12 that as the depth of the bed is decreased a more favorable (lower) pressure drop is observed but does not approach a reasonable limit until an equivalent bead diameter of about 50 microns, such that the overall volume of beads required for full extraction of the target 160 mg of TIE would exceed the size selected as a reasonable device area.

Accordingly, the use of the present inventive MIP polymer fibers configured into a web and/or a fabric constructed thereof and/or a device constructed thereof, represents a surprising and unexpected improvement in utilizing MIP polymers for effective extractions from a fluid wherein the object of the extraction process is to remove milligram and greater than milligram quantities of a desired TIE from the fluid using a more compact, condensed and efficient means that does not suffer from undesirable pressure drops and/or require an excessive volume or size of the resulting device to achieve such levels of extraction.

### MIP Polymer Fibers—Elevated Pressure Applications

Here we explore example embodiments of the present invention relating to MIP polymer fibers that are suitable for use where an externally applied or internally developed pressure can be utilized to assist in driving the fluid with the target entity to be extracted through an inventive device employing the inventive MIP polymer fibers and/or webs and/or an apparatus constructed thereof, with the object of extracting a significant fraction of the TIE material present from the fluid, retaining the TIE material onto the MIP polymer fibers.

Nevertheless, the use of both MIP polymer fibers, webs formed thereof, and apparatus containing the fibers and/or webs, when higher pressure drops can be accommodated remain viable for other extraction processes to remove a TIE from a fluid, unless other constraints act to limit the amount of applied pressure required by the system. For example in one embodiment, but not limited thereto, a fluid like blood containing red and white blood cells which is being treated with the use of an inline filter containing MIP polymer fibers may desirably be filtered at only low applied pressures as necessary to prevent damage or disruption to live cells present in the blood. In this preceding example embodiment, the selection of the MIP polymer material and parameters of the MIP polymer fiber web would preferably include systems in which the interstitial spacing between the fibers would be large enough to enable the free passage of red and white blood cells, for example, without damaging, capturing or rupturing them.

In other embodiments, higher pressures and more densely packed MIP polymer fibers can be selected in order to increase extraction efficiency per unit weight of the fibers, and to enable the use of higher pressures.

Consumer and industrial main water pressure is controlled at the municipal or water company pumping station, and is usually set between 150 and 200 psi. This is to overcome the pressure drop between pumping stations and elevated water towers and water storage tanks in high-rise buildings. Additionally, high pressure is required at roadside hydrants for fire-fighting purposes. To protect domestic and industrial plumbing installations and household appliances, city building codes call for a reduction in water pressure to between about 40 psi and a maximum of about 80 psi.

Accordingly, considering that home and industrial water systems may induce a further pressure drop owing to desalination systems and water usage will result in some degree of available water pressure reduction at outlets, it is reasonable in one embodiment to limit the maximum desired pressure drop to at or below around 40 psi to ensure that any device employing the inventive MIP polymer fiber webs to perform an extraction of a TIE from a solution does not require too high of an applied pressure higher than one can be driven by available water pressure. Of course, in other embodiments, a pump or other means of generating a pressurized fluid source can easily be used to create sufficient pressure to overcome the pressure drop of the inventive MIP polymer fiber web for extraction of TIEs from a pumpable fluid.

However, for purposes of illustration, we will now explore embodiments of the present invention employing MIP polymer fibers to extract caffeine from a pressurized fluid source as would be done at a commercial scale such as in a processing plant to remove caffeine on an industrial scale where hundreds or thousands of gallons of fluid are desired to be processed in the shortest time and most efficient means. Again, it is to be noted that this particular embodiment is selected as an example, and that the same inventive approach can be applied to extract any selected TIE from a fluid stream using MIP polymer fibers imprinted with the selected TIE.

To determine the scale of extraction required, one can estimate an average caffeine content in the two most common species of coffee beans, Arabica and Robusto, the former representing about 75% of all coffee consumed worldwide and having between about 1.2 to about 1.8 weight % of caffeine; and the latter having a reported caffeine content of about 2.4 weight %. Thus, a rough average of about 2.0 weight % of caffeine is a reasonable working assumption to use.

An estimate of approximate concentrations of the caffeine in a coffee extract can be made by selecting a concentration with a lower limit equivalent to that of a typical brew process, represented by a typical drip coffee process that uses about 5 grams of ground coffee beans per 95 grams of water (being 5 weight % based on rough estimates of a typical home brewing process conducted by inventor), and an upper limit based on a brief review of coffee extraction processes which use solutions of up to 30 weight percent.

Accordingly, one can assume a reasonable working range of between 5 to about 30 weight %, or alternatively between 10 to 20 weight %, or yet alternatively around about 15 weight % as a reasonably range and amount of caffeine present in a coffee extract to be treated to remove a significant fraction of the caffeine. However, caffeine has a solubility in water that varies with temperature, having a room temperature solubility of about 1 part caffeine in 46 parts of water by weight, while at 80° C. the solubility is about 1 part caffeine in 5.5 parts of water. Thus, a reasonable estimate taking into account the use of an elevated temperature above room temperature but below about 80° C., is about 1 part of caffeine per 20 parts of water by weight (See WWW website http://en.wikipedia.org/wiki/Coffee_bean, accessed on Dec. 28, 2014). Using this estimate, than one can calculate that for each 1,000 kg of coffee beans used, about 400 kilograms of water will used for extraction of the beans with an average of 2.0 weight % caffeine present in that quantity of beans as estimated above, yielding a likely commercial processing level of roughly about 5.0 weight % of soluble caffeine present in the coffee bean extraction water.

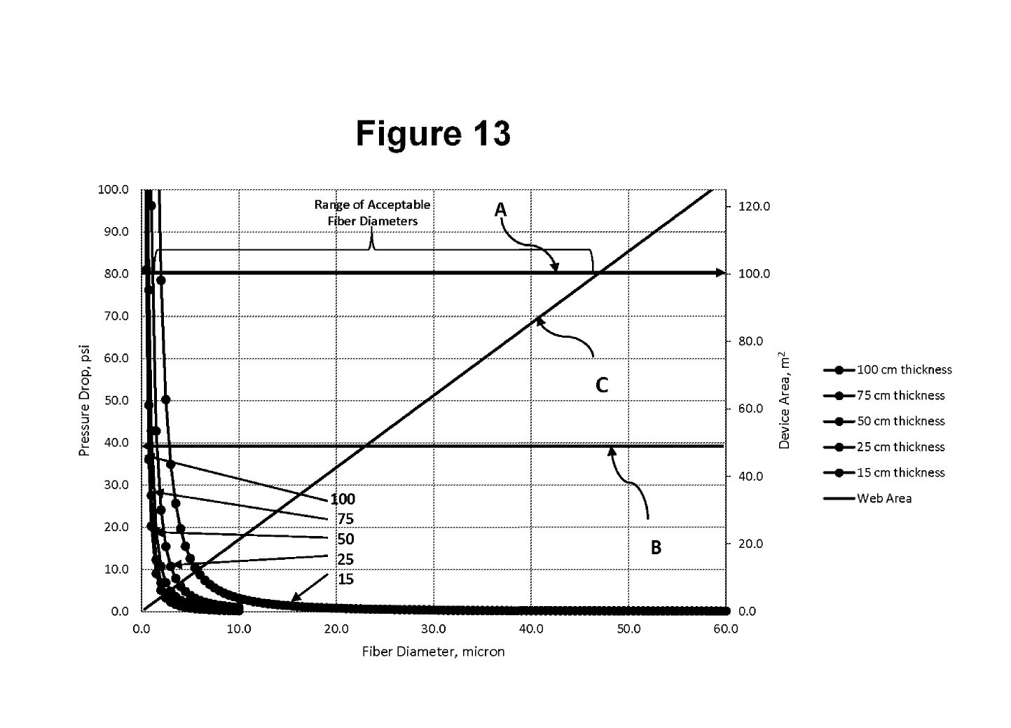

FIG. 13 is presented as an example of embodiments of the present invention in which MIP polymer fibers imprinted with caffeine as the target imprintable entity (TIE) are used in a process to remove multi-gram quantities of the material under commercial scale conditions assisted by the use of pressure to move the fluid through a fabric composed of the polymer fibers configured to operate as an in-line filter. For purposes of illustration, a fluid flow rate of about 25 cm/sec is assumed as a reasonable rate for purposes of calculating system response, and is not limited to this rate, which may vary over any suitable range depending on the process and process conditions, including for example between about 1 cm/sec to about 1000 cm/sec, or alternatively from between 5 cm/sec to about 500 cm/sec, or yet alternatively from between 10 cm/sec to about 100 cm/sec, the flow rate being selected under the process conditions at hand to optimize the contact time of the treated fluid with the inventive MIP polymer fibers versus the overall process time required to treat a particular volume of fluid containing the TIE to be removed by the MIP polymer fiber and/or web and/or device thereof in a timely and economical manner suited to a larger scale commercial process, wherein the process conditions are selected to enable removal of all the TIE, or a significant fraction thereof, from the treated fluid.

In FIG. 13, line “A” represents a selected limit of around about 100 m2 (square meters) of fabric surface area as one embodiment of a commercial filtering system, corresponding to the secondary or minor Y-axis (right) representing the Device Area. It is to be noted that the total nominal area does not necessarily require a single filtering device of this size, but reflects a total additive area of an example filtering system, which could for example, include multiple filtering units arranged in either a series configuration, and/or alternatively in a parallel configuration. Also shown in this figure, line “B” represents a selected pressure drop limit of around about 40 psi, corresponding to the primary Y-axis (left) representing the pressure drop at the surface of the filter device, selected as a reasonable upper limit for most commercial processes involving pressurized fluid treatment systems. In addition, line “C” illustrates the calculated surface area of the device, intersecting with line “A” at the maximum desired surface area limit of 100 m2, for an embodiment of the invention employing a MIP polymer fiber web in the form of a fabric having a basis weight of 20,000 g/m2. It should be noted that this very high basis weight (20,000 g/m2 or higher) can be achieved by layering several more standard webs (e.g., 100 g/m2) one upon another; or any other means envisioned. The five (5) traces in this same figure represent different fabric thickness of 15, 25, 50, 75 and 100 cm thicknesses.

In FIG. 13 it can be seen that fiber diameters for a 20 kg/m2 basis weight fiber between about 1.5 microns to just around about 47 microns (at a total fiber web thickness of 100 cm) have the requisite device area sufficient to bind up to the target amount of 20 kg (20,000 g) of the caffeine TIE, for device areas up to and including around 100 m2 surface areas, and a pressure drop of less than around 40 psi. This extent of surface area may be incorporated in one embodiment into a single filtering unit for use in a process stream, or in alternative embodiments be a series of separate filtering units having some fractional available surface area totaling the desired surface area, such as for example, representing four (4) filtering units in series each having 25 m2 surface areas, enabling the smaller individual filtering units to be swapped out and replaced with new or refreshed units during and/or between processing runs to extract a TIE from a fluid stream circulated through the filtering unit system.

In another embodiment, it may be desirable to minimize the total surface area of the inventive MIP polymer fiber device used, for example if limited to a single filtering unit, where size may be restricted due to physical constraints and/or where the filtering unit is to be used in a filtering system composed of a plurality of other similar filtering units.

In Table 8, the pressure drop and overall web volumes of several example embodiments (56-70) of inventive MIP polymer fibers configured into a filter for higher pressure commercial scale extraction of a target TIE, here for example using caffeine again as the selected TIE, are shown. Example embodiment 56 with a fiber diameter of 0.75 microns is just borderline with respect to the maximum desired pressure drop, for a web thickness of 100 cm, of about 36 psi, suggesting this value as an approximate lower fiber diameter limit for this configuration for large scale extraction purposes. Example embodiments 56 through 70, with fiber diameters ranging between 0.75 micron to 50.0 micron, respectively, all feature pressure drops of less than 40 psi.

Here it is noted that as fiber diameter increases, the favorable reduction in pressure drop is countered somewhat by the decreasing fiber surface area available for extraction of the TIE, as shown by examining the rightmost column of Table 8, where the MIP Density is seen to decrease from about 1.0E+16 to about 1.5E+15 in units of #Sites/cm3 of fabric, indicative of an decreasing number of MIP sites formed within the MIP polymer fibers being located on or near an accessible surface of the fibers as fiber diameters increase. Further, the amount of web area required to extract the target amount of caffeine (20 kg) increases significantly as fiber diameter increases, so that there is likely some practical limit in fiber size dictated by size constraints that apply to commercial operations.

TABLE 8
Pressure Drop and Overall Web Volume of Fiber Webs with Areal
Loft of 20,000 g/cm3 (Note 1):

| | Fiber | | | MIP Density |
|---|---|---|---|---|
| | Diameter d | Web Volume | Pressure Drop | (#Sites/cm³ of |
| Example | (microns) | (m³) | (psi) | Fabric) |
| A8 | 0.5 | 1.067 | 81.05 | 1.455E+17 |
| 56 | 0.75 | 1.601 | 36.02 | 9.967E+16 |
| 57 | 1.5 | 3.202 | 9.006 | 4.848E+16 |
| 58 | 2.0 | 4.269 | 5.006 | 3.636E+16 |
| 59 | 2.5 | 5.336 | 3.242 | 2.909E+16 |
| 60 | 3.0 | 6.403 | 2.251 | 2.424E+16 |
| 61 | 4.0 | 8.538 | 1.266 | 1.818E+16 |
| 62 | 5.0 | 10.672 | 0.811 | 1.455E+16 |
| 63 | 10.0 | 21.344 | 0.203 | 7.273E+15 |
| 64 | 15.0 | 32.017 | 0.090 | 4.848E+15 |
| 65 | 20.0 | 42.689 | 0.051 | 3.636E+15 |
| 67 | 30.0 | 64.033 | 0.023 | 2.424E+15 |
| 68 | 35.0 | 74.705 | 0.017 | 2.078E+15 |
| 69 | 40.0 | 85.378 | 0.013 | 1.818E+15 |
| 70 | 50.0 | 106.722 | 0.008 | 1.455E+15 |

Notes:
(1) Based on flow rate of about 25 cm/sec with pressure drop calculated at fluid entry point at fiber web (fabric) surface; other parameters as indicated in the table above or in Table 1.

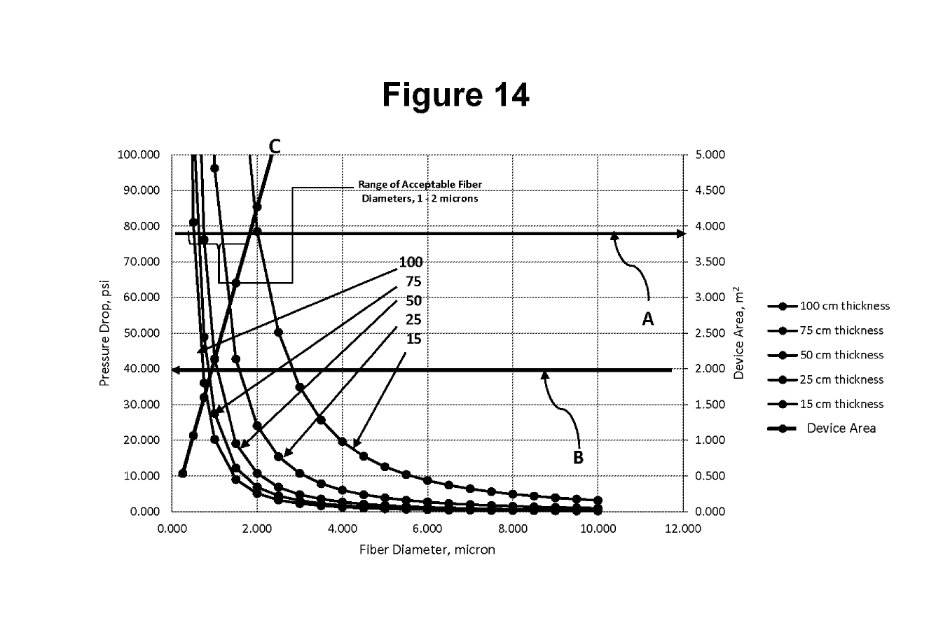

In another series of embodiments, a device according to the present invention is selected to have a total device area not to exceed around 4.0 m2, and a desired pressure drop not to exceed around about 40 psi for a non-woven fabric composed of the MIP polymer fibers having an effective Areal (loft) value of about 20,000 g/m2. Plots of the pressure drop versus embodiments of the invention featuring various fiber diameters are shown in FIG. 14.

In FIG. 14, line “A” represents a selected limit of around about 4 m2 (square meters) of fabric surface area as one embodiment of a commercial filtering system, corresponding to the secondary Y-axis (right) representing the device area. It is to be noted that the total nominal area does not necessarily require a single filtering device of this size, but reflects a total additive area of an example filtering system, which could for example, include multiple filtering units arranged in either a series configuration, and/or alternatively in a parallel configuration. Also shown in this figure, line “B” represents a selected pressure drop limit of around about 40 psi, corresponding to the primary Y-axis (left) representing the pressure drop at the surface of the filter device, selected as a reasonable upper limit for most commercial processes involving pressurized fluid treatment systems. In addition, line “C” illustrates the calculated surface area of the device, intersecting with line “A” at the maximum desired surface area limit of 4 m2 for this particular embodiment of the invention employing a MIP polymer fiber web in the form of a fabric having a basis weight of 20,000 g/m2. The five (5) traces in this same figure represent different fabric thickness of 15, 25, 50, 75 and 100 cm thicknesses. A flow rate of about 25 cm/sec for the extraction process is selected for purposes of illustration here.

In FIG. 14 it can be seen that fiber diameters for a 20 kg/m2 basis weight fiber between about 0.75 micron to just around about 2.0 microns have the requisite device area sufficient to bind up to the target amount of 20 kg (20,000 g) of the caffeine TIE, for device areas up to and including around 4.0 m2 surface areas. This extent of surface area may be incorporated in one embodiment into a single filtering unit for use in a process stream, or in alternative embodiments be a series of separate filtering units having some fractional available surface area totaling the desired surface area, such as for example, representing four (4) filtering units in series each having 1.0 m2 surface areas, enabling the smaller individual filtering units to be swapped out and replaced with new or refreshed units during and/or between processing runs to extract a TIE from a fluid stream circulated through the filtering unit system.

In other embodiments, the selected Areal of a fabric composed of the inventive MIP polymer fibers can be chosen to tailor a TIE extraction device having a desired device area and/or web volume and/or pressure drop, as shown in Table 9.

TABLE 9
Pressure Drop and Web Volumes for Various Areal Values and
Web Thicknesses (Note 1):

| | | | t, web | Web | |
|---|---|---|---|---|---|
| | Γ, Ariel | d | thickness | Volume | Pressure |
| Example | (g/cm²) | (microns) | (m) | (m³) | Drop (psi) |
| 71 | 20,000 | 0.75 | 1 | 1.60 | 36.0 |
| 72 | 20,000 | 2.5 | 1 | 5.30 | 3.24 |
| 73 | 20,000 | 8.0 | 1 | 17.1 | 0.317 |
| 74 | 20,000 | 26.0 | 1 | 55.5 | 0.030 |
| 75 | 20,000 | 60.0 | 1 | 128.1 | 0.001 |
| 76 | 40,000 | 1.5 | 2 | 3.20 | 18.0 |
| 77 | 40,000 | 3.0 | 2 | 6.40 | 4.50 |
| 78 | 40,000 | 5.0 | 2 | 10.67 | 1.62 |
| 79 | 40,000 | 16.0 | 2 | 34.2 | 0.158 |
| 80 | 40,000 | 55.0 | 2 | 117.4 | 0.013 |
| 81 | 60,000 | 2.5 | 3 | 5.34 | 9.73 |
| 82 | 60,000 | 3.0 | 3 | 6.40 | 6.75 |
| 83 | 60,000 | 4.5 | 3 | 9.61 | 3.00 |
| 84 | 60,000 | 6.0 | 3 | 12.81 | 1.69 |
| 85 | 60,000 | 9.0 | 3 | 19.21 | 0.75 |
| 86 | 100,000 | 4.5 | 5 | 9.61 | 5.00 |
| 87 | 100,000 | 19.0 | 5 | 40.55 | 0.28 |
| 88 | 100,000 | 38.5 | 5 | 82.2 | 0.068 |
| 89 | 200,000 | 33.5 | 10 | 71.5 | 0.18 |
| 90 | 200,000 | 44.0 | 10 | 93.9 | 0.11 |
| 91 | 200,000 | 60.0 | 50 | 128.1 | 0.06 |
| 92 | 400,000 | 11.5 | 20 | 24.55 | 3.06 |
| 93 | 400,000 | 60.0 | 20 | 128.1 | 0.113 |
| 94 | 400,000 | 4.5(2) | 20 | 0.192 | 20.0 |
| 95 | 400,000 | 9.0(2) | 20 | 0.384 | 5.00 |
| 96 | 400,000 | 45.0(2) | 20 | 38.4 | 0.20 |
| 97 | 400,000 | 60.0(2) | 20 | 51.2 | 0.133 |

Notes:
(1) Calculated assuming a flow rate of 25 cm/sec; other parameters as indicated in table above or in Table 1.
(2)Examples 94-97 are using fibers extruded using 4DG ™ Fiber technology as described herein, being surface area enhanced fibers with a surface amplification factor considered here of 2.5, or 250% increased effective surface area versus a smooth-surfaced round fiber.

In Table 9, example embodiments 71-97 represent various MIP polymer fiber diameters and web configurations, defined by the Areal (loft) of a non-woven fabric formed using the fibers, and formed at various web thicknesses. Examples include embodiments of the inventive MIP polymer fiber webs having Areal values between about 5,000 to 400,000 (g/cm2), and fiber webs having thicknesses of between about 2 cm to about 2000 cm in depth. As can be seen in Table 9, various combinations of Areal, web thickness and fiber diameter may be selected to achieve web volumes varying from about 1.0 m3 to about 125 m3. Alternatively, other combinations of Areal, web thickness and fiber diameter may be selected to enable a device constructed using the fabric therein to operate with a pressure drop between about 3 to about 42 psi, using the extraction of caffeine as a TIE from a caffeine solution on the order of 20 kg capacity on the inventive device formed using the inventive MIP polymer fibers.

In Table 9, the example embodiments presented illustrate the breadth of the current inventive approach to constructing an extraction device using MIP polymer fibers formed into a web. Here, using an example web having an Areal of 7,500 g/m2, and a selected web volume of just around 1.1 m3 (from 1.07 to 1.14), it is seen that one can select an appropriate fiber diameter and/or web thickness to achieve a particular desired pressure drop. Fiber diameters of between 0.75 micron to about 10 microns in web depths (thicknesses) ranging from 25 cm to 2 cm, for example, provide a device that can operate with any desired pressure drop between from about 21 psi to about 4.7 psi. Of course, other combinations of these parameters can be selected in a similar manner to find MIP polymer fiber web configurations with any desired pressure drop from an upper practical range of about 40 psi to below about 0.3 psi, spanning both commercial, retail and manual ranges of pressure conditions that the inventive device is desired to operate within for pressurized and non-pressurized (manual) extraction operations to remove any selected TIE from a fluid.

In Table 9, example embodiments 94-97 reflect use of the 4DG™ Fiber technology as described herein to produce highly contoured surfaces on fibers resulting in an effective amplification of available surface area. Here, assuming a minimum amplification factor of 2.5, it is seen by comparing example embodiments 92 and 94, that the latter device using the 4DG fiber technology is able to extract the same target amount of caffeine (4 kg) with a web volume of only 3.84 m3 compared to the required web volume of 24.55 m3 for a typical round profile fiber (amplification factor=1).

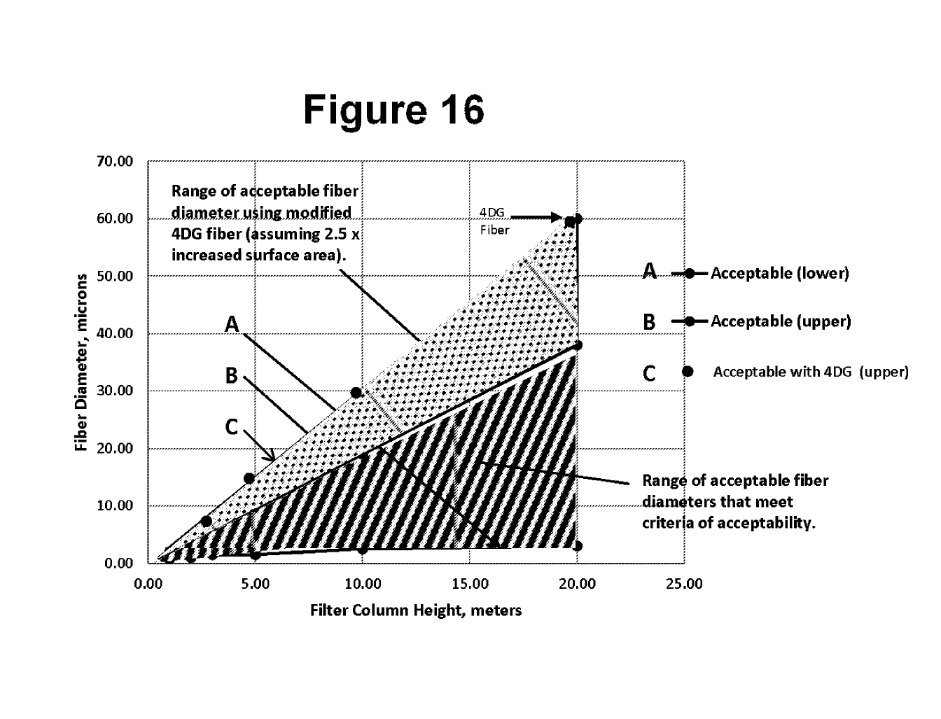

Advantages of selected embodiments of the present invention employing fibers with surface convolutions or cross-sectional shapes providing effective surface amplification factors greater than 1 (round cross-sectional fiber) can be seen by examining FIG. 16.

In FIG. 16, a series of embodiments are shown, represented by a graph plotting acceptable fiber diameters for a commercial decaffeination process using the same parameters as above for extraction of a target 4 kg of caffeine from a process fluid, versus a total fiber column height in meters, representing the total height of the fiber web device, which could in alternative embodiments be a single filter unit or a series of filter units having the same total combined height as indicated. Here it is seen that a lower fiber diameter of between 0.05 microns to about 3 microns depending on the desired filter column height defines the lower extent of a range of acceptable fiber diameters (trace A). The upper extent of the range of acceptable fiber diameters for round fibers is defined by trace B, so that the lower shaded region represents all possible combinations of fiber diameters (in microns) and fiber column height (in meters) capable of extracting the target amount of the selected TIE (here, caffeine).

In contrast, if fibers with surface convolutions providing an effective surface area amplification are employed, such as the 4DG™ Fibers described herein (which have an amplification factor of at least 2.5), then additional fiber diameters are enabled, with an upper extent of the range of acceptable surface modified fiber diameters now defined by line “C”, so that the upper shaded region now includes additional combinations of fiber diameters (in microns, representing the average fiber diameter) and fiber column height (in meters) capable of extracting the target amount of the selected TIE (here, caffeine).

Table 10 shows a series of additional embodiments having acceptable MIP polymer fiber diameters in the form of filters capable of the extraction of 4 kg of caffeine as the selected TIE, in which the MIP polymer fibers are formed into filter webs as indicated, all exhibiting a desired pressure drop of less than about 40 psi. Standard round fibers are compared to fibers having an enhanced surface area or surface area amplification factor greater than 1.0. Table 10 shows example embodiments 98-104, representing a range of MIP polymer fiber diameters, expressed as a range between an approximately lower limit and an approximately upper limit, respectively, of fiber diameters having a suitable extraction efficacy and of filters formed thereof, exhibiting a pressure drop of less than or equal to the desired maximum pressure drop of 40 psi.

TABLE 10
Acceptable MIP polymer fiber diameter ranges for extraction
process using a filter exhibiting an acceptable pressure drop.

| | | | | Fiber | Fiber |
|---|---|---|---|---|---|
| | | | | Diameter | Diameter |
| | Filter | Filter | | (microns) | (microns) |
| | Height | Weight | | (lower | (upper |
| Examples | (m) | (kg/m²) | Fiber Type | limit)(1) | limit)(1) |
| 98 | 1.00 | 20.0 | round(2) | 0.75 | 2.00 |
| 99 | 2.00 | 40.0 | round | 1.00 | 4.00 |
| 100 | 3.00 | 60.0 | round | 1.50 | 6.00 |
| 101 | 5.00 | 100.0 | round | 1.50 | 9.50 |
| 102 | 10.00 | 200.0 | round | 2.50 | 19.00 |
| 103 | 20.00 | 400.0 | round | 3.00 | 38.00 |
| 104 | 20.00 | 400.0 | 4DG ™(3) | 3.00 | 60.00 |

Notes:
(1)Approximate lower and upper limits within experimental accuracy of about +/−10% of the value indicated.
(2)Amplification factor for standard round fiber is 1.0
(3)Amplification factor of 2.5 used.

Accordingly, fiber diameters from about 0.75 micron to about 38 microns can be selected for manufacturing a fabric web using MIP polymer fibers that can effectively remove 4 kg of a selected TIE from a fluid under process conditions enabled by having less than about a 40 psi pressure drop across the fabric web. Further, the range of suitable fiber diameters that can be used under the same conditions as immediately stated above, can be extended from about 0.75 micron to about 60 microns if fibers having a surface amplification factor greater than 1.0 are employed instead.

Fibers with greater surface amplification factors would result in a corresponding increase in the range of available fiber diameters and filter depth (fiber web thickness) that could be used for extraction of a selected TIE according to the inventive methods and apparatus described herein employing MIP polymer fibers modified to have increased surface areas compared to typical round fibers.

### MIP Polymer Beads Under Higher Pressure Applications

In this section, the use of MIP polymer fibers is compared to the use of non-inventive round MIP polymer beads for a comparative example involving a targeted extraction of 20 kg of caffeine under higher pressure applications.

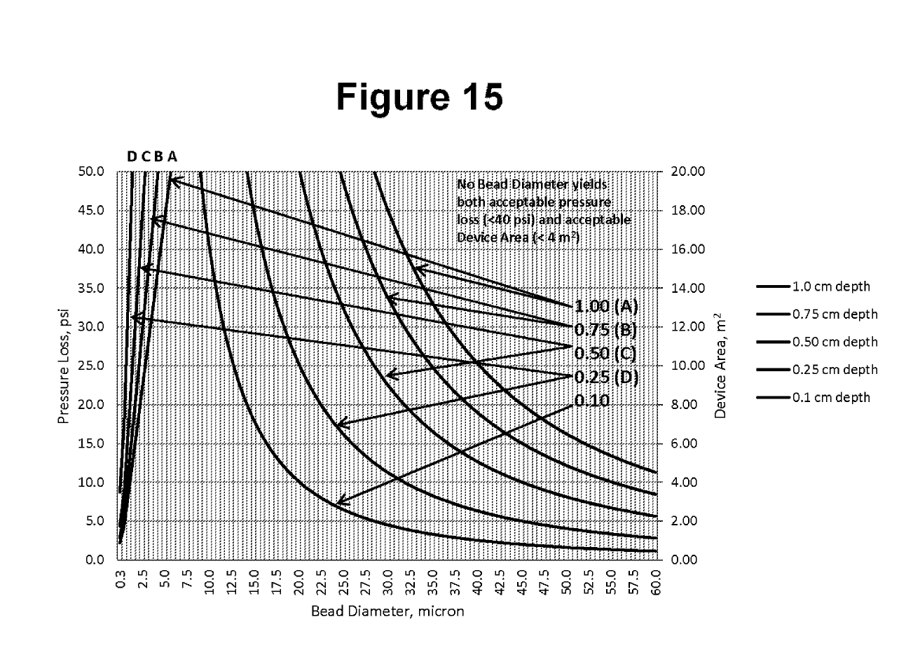

FIG. 15 shows a plot of the pressure drop (psi) versus device area (m2) for a selection of MIP polymer beads of varying diameters configured into five different bead bed depths of from 1.0 cm to 0.1 cm heights. Traces A, B, C, D on the left side of FIG. 15 show the required device area required in order to have sufficient MIP binding sites present on the surface of the beads to extract the requisite 20 kg of the selected TIE, here in this comparative example being caffeine in order to contrast to the inventive MIP polymer fiber apparatus described herein. Corresponding to the traces A, B, C and D (plotted against the secondary or right Y-axis) are the curves representing the pressure drop in psi plotted on the primary (left) Y-axis against the corresponding MIP polymer bead diameters, 1.0 cm, 0.75 cm, 0.50 cm and 0.25 cm (except for bead depth of 0.10 cm for which the device area trace is too close to the primary (left) Y-axis to show).

Under fluidic pressure and flow, the assumption of the beads packing into a face centered cubic (FCC) arrangement is a reasonable assumption, thus the system of packed round bead beds would have a packing efficiency of 74% as disclosed hereinabove, having a corresponding packing order (Φ) or 26%. A flow rate of 25 cm/sec is used as well so that the system is equivalent to that of an inventive MIP polymer fiber web extraction system with respect to the number of available MIP binding sites for a similar weight (quantity) of MIP polymer. However, in contrast to the inventive MIP polymer fiber web disclosed herein, no bead diameter and bead bed depth combination is capable of having sufficient MIP binding sites on their surfaces sufficient to achieve the total 4 m2 surface area required to extract the target amount of the TIE, here being 4 kg of caffeine within the selected pressure drop range of at or below about 40 psi.

Accordingly, the inventive MIP polymer fibers and/or webs constructed thereof and/or an apparatus constructed thereof, provide a surprising and novel approach to extract gram and higher amounts of a selected TIE from a fluid without suffering from the consequences of a high pressure drop that would otherwise prevent effective penetration of a fluid in the extraction bed and sufficient device area for near complete extraction of the desired quantity of TIE, even under reasonable pressure drop conditions that can be brought to bear in a larger scale and/or commercial process.

### MIP Polymer Fiber Morphology

In other embodiments, the inventive MIP polymer fibers and/or webs and/or an apparatus constructed thereof, may employ textured or lobed fibers in addition to, or instead of the typical round (circular) cross-sectional fibers common to the art. One commercially available process suitable for producing lobed fibers is Fiber Innovation Technology's 4DG™ Deep-Grooved Fiber technology developed in collaboration with Clemson University. Fiber Innovation Technology (398 Innovation Drive, Johnson City, Tenn. 37604) claims that their process increases available longitudinal surface area by at least a numerical factor of between 2.5 to 3.0 with respect to identical cross-sectional area sized round fiber, having a nominal shape factor of 1, producing increased surface areas of between 250 to 300% greater than a round fiber.

Further, due to the textured surfaces providing minor and major grooves to promote fluid flow, an additional benefit exhibited in a packed web of surface textured fibers is an additional factor of 1.0 to 1.5 available surface area for contacting the fluid versus round fibers which produce exclusion zones at every point of contact between the fibers because the smooth surfaces of typical round fibers form close contacts that preclude fluid passage, while grooved fibers do not or act less so. Accordingly, an effective surface area amplification factor of between 3.5 (2.5 shape factor +1.0 additional fluid accessible surface area factor) and 4.5 (3.0+1.5), respectively, may be obtained. For purposes of calculation, an average amplification factor of 4.0 is considered a reasonable assumption.

Other commercially available fibers and processes to make high surface area enhanced fibers include Capillary-Channeled Polymer (CCP™) fibers from Specialty & Custom Fibers, LLC (P.O. Box 968, Clemson, S.C. 29633), which offer similar usable surface area amplification factors as the 4DG™ Deep-Grooved Fiber technology described herein.

Other fiber forming technologies are also suitable for use in forming the inventive MIP polymer fibers including the technique described by Xue, et al., in U.S. Pat. No. 6,779,528 (issued Aug. 24, 2004), and incorporated in its entirety herein by reference. Xue et al. use a vacuum aided evaporative process during fiber extrusion to form a plurality of micro-cavities along the longitudinal surface of the fiber as it is drawn, vacuum is applied to the thus formed fibers after a certain degree of drying. A dried outer skin is formed, and the vacuum causes the solvent inside the skin to explode or pop and exit the fiber along micro-porous paths thereby producing high surface area fibers with micro-porous cavities and internal void volume that is now accessible to fluid contact.

Another acceptable approach to producing the inventive MIP polymer fibers to enhance available surface area and also to increase both permeability and porosity, is to include water and/or extraction fluid soluble ionic salts and/or ionic compounds, such as for example, but not limited to sodium chloride, potassium chloride, and/or other ionic solids that can be micronized with ease and included in the polymer with a target TIE without interference in the formation of the TIE receptor site, such that the ionic salts are trapped within the polymer matrix in addition to the TIE materials during polymer hardening or cross-linking. This approach results, after extraction of both the TIE and the ionic salt material, in the formation of the desired TIE receptor sites; and in addition, formation of other pores, holes, void spaces, and channels formed by extraction of the salt, respectively, thus decreasing the amount of MIP polymer material needed by correspondingly increasing the effective number of desired TIE receptor sites per unit polymer mass. As noted above, an added advantage is an increase in porosity and ultimately increasing the more critical permeability characteristic of a fiber web formed using the inventive MIP polymer fibers so as to enable increased TIE extraction efficiency by promoting additional fluid flow and contact with an increased number of TIE sites now exposed to the fluid as a result of using this method to form the MIP polymer fibers as described above.

Another acceptable approach to producing the inventive MIP polymer fibers is to employ a core-sheath process to create a multi-component fiber in which a first center core polymer material is formed having an outer, generally continuous coating of a second polymer material, the latter selected according to the present invention to be a MIP polymer with target entity imprinted sites formed within. Examples of suitable processes to make these bi-component core/sheath polymer fibers include those described by Berger in U.S. Pat. No. 5,620,641 and by Kochesky, et al. in U.S. Pat. No. 5,284,704, both of which patents are hereby incorporated in their entirety by reference.

Further, a core/sheath fiber morphology and various acceptable means to form them are well known in the fiber arts, and when applied to the instant invention, provides the advantage of reducing the amount of MIP polymer material needed, by replacing the generally inaccessible core of a fiber with the first polymer material, which is not target entity imprinted. Thus, this alternative approach offers a significant cost, process and time advantage, and also enables more efficient post extraction of the target entities from the MIP target entity imprinted sheath layer, since it's surface area is increased and as well, the core material does not contain any extractable entities, being another polymer material.

Yet another acceptable approach to producing the inventive MIP polymer fibers is that described by Pourdeyhimi, et al. in U.S. Pat. No. 7,883,772, hereby incorporated in its entirety by reference, which discloses a process to make a multicomponent, multilobal fiber around a contiguous core fiber that is essentially enwrapped by the multilobal sheath fiber component so that the latter forms the entire outer surface of the multicomponent fiber, which optionally provides a secondary process wherein the core fiber component and the multilobal sheath fiber components can be sized such that the multicomponent, multilobal fiber can be fibrillated to expose the core fiber component and split the fiber into multiple microdenier fibers.

A key advantage of adapting this approach to use with MIP polymer fibers is that the core fiber can be made of any desirable polymeric material, whether or not optimal for MIP entity imprinting, while the outer sheath material is constructed of MIP entity imprinted polymer material prior to drawing and fiber production, thus substantially reducing the amount of surface bound MIP polymer material required without reduction in the overall binding efficacy because substantially all the MIP polymer is located on the surface and can be contacted by the fluid bearing the entity to be extracted. A further advantage of this adapting this approach to use with the present invention, is that the core polymer material can be selected independently from that of the sheath polymer, provided that the two polymer materials are at least process compatible, although the technique does not require the two polymer components to be melt-compatible.

Thus, a core/sheath fiber produced by the method of Pourdeyhimi, et al. enables selection of a core material that is less expensive, or stronger, or exhibits any other beneficial property independent of the sheath material that incorporates the MIP binding sites for the target entity. Further, the method of Pourdeyhimi, et al. also enables the outer sheath to be lobed and/or convoluted to increase its effective surface area, providing a further amplification with respect to the number of MIP target entity binding sites available for a given polymer fiber size or weight.

Accordingly, these and other variations common to the art may be employed to produce and/or modify polymeric fibers to produce extremely high surface area MIP polymer fibers with amplified binding efficacies compared to the use of round single fibers and/or round core/sheath fibers.

### MIP Polymer Fiber Web Apparatus

As discussed herein and illustrated by numerous examples of inventive embodiments herein, the inventive MIP polymer fibers and/or webs formed thereof, can be formed, fashioned into, or contained within a apparatus to assist in the extraction of any target entity capable of being molecularly imprinted into a polymer or polymeric matrix.

The inventive MIP polymer fibers may be incorporated into a fabric web of any desired configuration, geometry, shape and size; and produced by any suitable means known to one skilled in the art, including, but not limited to fabric webs produced by wet-spinning, dry-spinning, melt-spinning, electro-spinning, melt blowing, spun-bonding, spin-lacing, needle-punching, carding, drawing, air-laying, wet-laying, hydro-entangling, weaving, bundling, bunching, depositing and/or solvent-casting and/or coating onto a support string or wire or membrane or surface of a supporting film or structure, confining and/or forming between two or more supporting fabrics, meshes, membranes, or the like; and/or other methods capable of producing a three-dimensional (3D) structure composed of the inventive MIP polymer fibers.

In turn, the inventive MIP polymer fiber webs can subsequently be altered, formed, pressed, shaped or configured into any desired final three dimensional form depending on the nature of the polymer(s) selected and the intended use, providing that such subsequent configurations do not substantially alter the desired properties of the fibers and/or webs formed thereof.

Forms of the resulting inventive device include a spoon, fork or shape resembling a utensil, stir stick, stir bar, whip, drinking straw; as well as being in the form of a web, layer or coating attached to, formed on or integrated into a surface, such as the inside of a vessel, cup, conduit, pipe, container or package in which a fluid to be treated is contained for at least the minimum sufficient time required to achieve the desired level of extraction of a target entity from the fluid by the inventive MIP polymer fibers comprising the device. These forms would enable use of the inventive device to extract a target entity from a beverage, such as caffeine from coffee as explored in detail herein, as well as any another imprintable entity, including but not limited to removal of sugar, sucrose, glucose, fructose, selected artificial sweeteners, salt, selected coloring agents, selected preservatives, selected impurities (such as for example, but not limited to drugs and undesirable contaminants naturally or deliberately introduced to the fluid) and other target imprintable entities (TIEs) that are typically present in water, beverages, juices, extracts, condiments or other liquid food products, and which TIEs would desirably be removed by use of the inventive MIP polymer fibers and/or webs constructed thereof, in the form of some device and/or apparatus.

In addition, the inventive MIP polymer fibers and/or webs thereof, may optionally be constrained onto a supporting means, such as, but not limited to a wire or mesh or surface, and/or within a containing and/or supporting structure that operate to either maintain the MIP polymer fibers and/or webs thereof in a stable manner, and/or prevent the fibers and/or webs from being displaced into or taken up by the fluid undergoing an extraction process and/or regeneration process.

As illustrated in multiple inventive embodiments described herein, an apparatus employing the MIP polymer fibers and/or webs constructed thereof, may be used in manual stirring applications and the like to remove any desired TIE from a fluid without the application of external pressure, fluid flow from motion either imposed by manual or mechanical stirring and/or agitation and/or the like being sufficient. In addition, an apparatus employing the MIP polymer fibers and/or webs constructed thereof, may be used in TIE extraction process where the fluid flow is simply induced by gravity, such as for example, but not limited to, an apparatus in the form of filters and/or filter elements and/or filter beds in which the natural flow of the fluid assisted by gravity is sufficient to produce a pressure drop of about 0.3 psi, or less.

For larger scale extractions where an applied pressure (either externally or internally produced) can be utilized, an apparatus employing the inventive MIP polymer fibers and/or webs constructed thereof, may be used to extract gram and larger quantities of a desired TIE from a fluid, enabling the use of the inventive MIP polymer fibers for various retail and commercial applications as described herein.

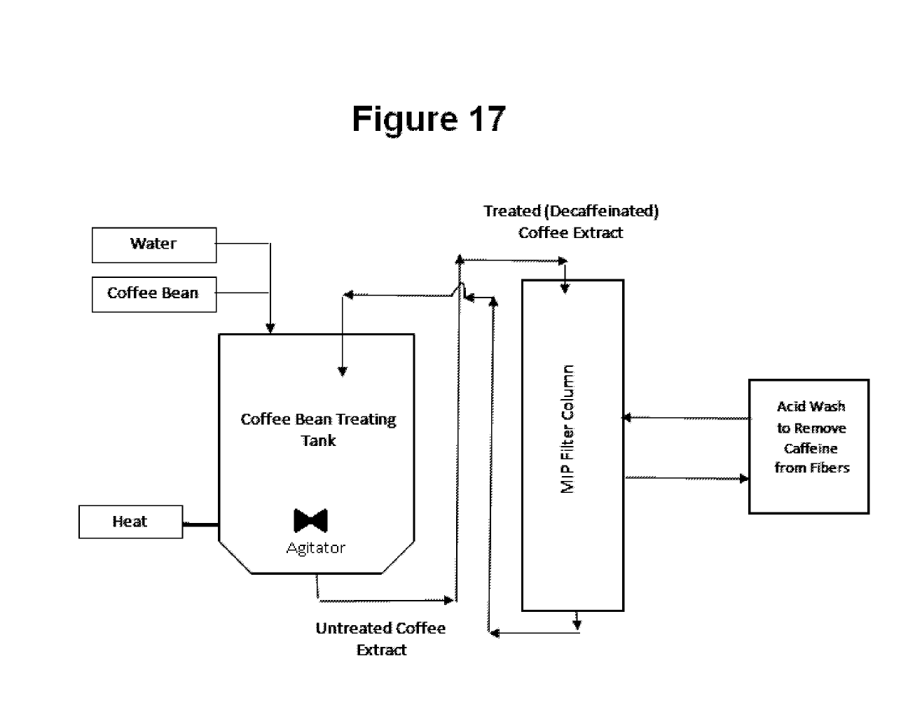

In one example embodiment, again using caffeine as the selected TIE for a larger scale extraction of multi-gram quantities of material from a fluid, FIG. 17 may be referred to and represents a pictographic commercial process flow diagram for the extraction of caffeine from coffee beans and/or liquid coffee extract. In FIG. 17, water and coffee beans containing caffeine are placed into a coffee bean treating tank and heat and agitation supplied to facilitate solubilization of the caffeine from the beans into the coffee extract fluid. Optionally, either in a batch mode or a continuous flow mode (as shown here), the untreated coffee extract fluid is pumped through an inventive MIP polymer filter column composed of fibers and/or fiber webs and/or fabrics and/or filter plates constructed of the MIP polymer fibers selected according to the methods of the present invention to have the desired number of available MIP polymer TIE binding sites and an acceptable pressure drop across the device.

In a continuous process mode, the treated (decaffeinated) coffee extract fluid is then pumped (recirculated) back into the coffee bean treating tank to facilitate additional removal of the TIE, or in a batch process mode, the pumping rate is adjusted to provide sufficient contact time between the untreated coffee extract fluid and the inventive MIP filter column device to afford the desired level of extraction of the TIE. Further, after the extraction of the TIE is completed, the inventive MIP filter column device is isolated from the process and treated to remove the adsorbed TIE and regenerate an operable filter for an addition extraction process, the TIE being recovered during the regeneration process. For caffeine, the use of a mild acidic water rinse improves the solubility of the material, aiding in its recovery from being bound to the inventive MIP polymer fibers. In other embodiments, different regeneration approaches, using water and/or other solvents and/or other fluid conditions can be employed to remove the extracted TIE from the inventive MIP polymer fiber device in order to generate the device and recover the TIE material for other uses.

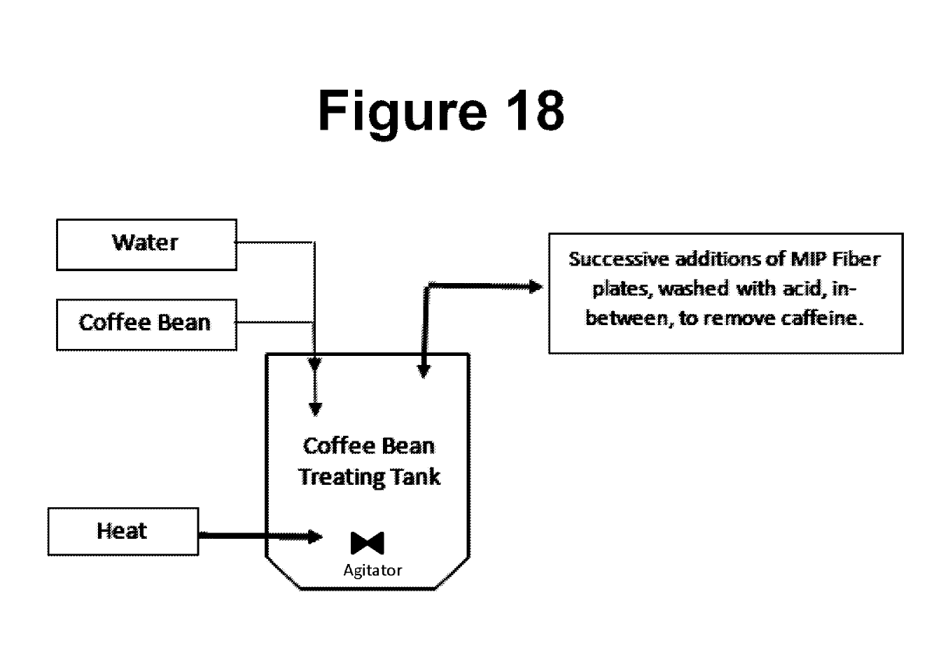

In another inventive embodiment, a batch style extraction process is presented in pictographic form in FIG. 18, which shows a batch process example again using caffeine extraction as an example. Here, the fluid to be extracted is prepared in a similar manner to that in the continuous process presented herein in FIG. 17. However, an apparatus composed of the inventive MIP polymer fibers and/or webs and/or filter plates composed thereof, are introduced into the TIE solution in order to extract the TIE (here, caffeine) and then removed in order to be regenerated and to recover the extracted TIE. In such a batch mode, agitation will not necessarily be sufficient to generate a higher pressure drop across the inventive MIP polymer fiber device as would a pump or other means used to transfer liquid capable of building a head pressure, but sufficient agitation could likely be applied to produce sufficient fluid flow through a submerged filtering element to produce elevated pressure drops of greater than 0.3 psi as in the case of simple manual (human) stirring.

Accordingly, in this and similar embodiments employing the inventive MIP polymer fibers and/or webs thereof, the extraction device would optimally be constructed to target the desired level of extraction, while balancing the total device surface area available and the polymer fiber web characteristics, including various combinations of Areal, fiber diameter, fiber morphology, fiber bed depth, device size and/or combinations of selected parameters thereof, in order to have a sufficiently low pressure drop to operate under the ultimate conditions desired.

In a series of embodiments, a MIP polymer fiber device that is useful for extraction of a selected TIE from a fluid under batch style conditions for removing gram and greater amounts of extracted TIE, can be fashioned having a pressure drop at the surface of the device of between about 0.3 psi and 40 psi, or alternatively between about 0.3 psi and 30 psi, or alternatively between about 0.3 psi and 20 psi, or alternatively between about 0.3 psi and 10 psi, or yet alternatively between about 1 psi to 5 psi.

Naturally, the MIP polymer fibers, webs and an apparatus constructed thereof in the above inventive embodiments illustrating the extraction of caffeine can be substituted with MIP polymer fibers imprinted with any desired TIE, and a similar process and selection of desired Areal values, fiber diameters, fiber morphologies, web construction and web thicknesses employed in a similar manner as illustrated hereinabove.

### MIP Polymer Fibers for Extraction of TIEs From Gaseous Fluids

Uses of the inventive MIP polymer fibers in webs and an apparatus for extraction of TIEs from a fluid are not limited to liquid fluids, but can also be used to treat gaseous fluids and fluidic vapors containing a desired TIE or multiple number of desired TIEs to be extracted therefrom.

A common gaseous fluid is air, which is a mixture of molecular and atomic gases as well as inorganic and organic materials that either have a vapor pressure and are present in a gaseous state, and/or are suspended in the air in the form of liquid droplets and/or solid particles (which could include for example, but not be limited to, a single entity such as a pollen spore, a virus, a bacterium, a phage or a prion) and/or combinations thereof. Other gaseous fluids include other gases such as molecular species including but not limited to oxygen, nitrogen, carbon monoxide, carbon dioxide, nitrogen and sulfur dioxides, and the like, as well as atomic gaseous species such as the noble gases including but not limited to argon, xenon, radon and the like. In addition, fluids include elements and molecular compounds with vapor pressures sufficient to render than as gaseous species under conditions of pressure and temperature of interest, being room temperature or either some elevated temperature, or conversely, some reduced temperature rendering the gaseous element or compound into a liquid fluid at some stage during a treatment or extraction process, such liquid fluid including for example, but not limited to bromine at or below normal room temperatures, or propellants such as fluorohydrocarbons (CFHCs), chlorofluorohydrocarbons (FHCs) and/or Freon™ (an FHC, available from the DuPont Chemical Company, Akron, Ohio, USA), which are liquids when under pressure.

For purposes of illustrating the utility of the present invention regarding the use of MIP polymer fibers to extract a desired TIE from a fluid, the following embodiments explore the removal of benzene vapor present in air using an inventive device composed of MIP polymer fibers imprinted with benzene, which is then extracted to leave MIP polymer fibers fashioned into a filtering element to be used for example, but not limited to, a personal respiratory filter incorporated into a gas mask.

The US EPA (Environmental Protection Agency, see Website corresponding to http://www.epa.gov/ncea/efh/pdfs/efh-chapter06.pdf, page 31, visited Dec. 30, 2014) provides data concerning the volume of air an adult breathes in a 24 hour period, as approximately being, for a male adult about 17 m3/day, while for a female adult about 13 m3/day. Since the typical male consumes more air than a female, we will use the male as a more challenging case. For a 30 minute exposure time (0.5 hours), the total volume of air consumption would be (for a male) equal to 17 m3×0.5 hrs/24 hrs or roughly about 0.35 m3 per day, which converted to liters for easier manipulation is approximately 350 liters. At standard temperature and pressure (STP, 20 oC. and 1 atmosphere pressure), one mole of gas occupies 22.4 liters of volume. Therefore, in 30 minutes, the typical adult male would breathe in about 15.6 moles of air.

Now, considering that a contaminant (for example here, benzene) is present at an undesirable limit of 10,000 ppm (0.1 wt %)in that volume of air, then in 30 minutes (taking the weight of 1.0 mole of dry air being equal to about 0.0289644 kg/mol) the typical adult male would breath in the equivalent of (15.6 moles ×0.02896 kg/mole ×1000 g/kg) or about 452 g of air. If the benzene contaminant is present at 0.10 wt %, then this corresponds to about 0.452 g of benzene (452 milligrams) to be extracted from that volume of air assuming a desired extraction efficiency capable of adsorbing all of the benzene in the respired air that is inhaled by the example male using an inventive MIP polymer fiber device imprinted to extract benzene as the TIE.

Additional parameters and values needed to use the model include the molecular weight of benzene (MWTIE) which is 78 g/mole, a reasonable estimate of respiration or flow rate (V) of about 100 cm/sec corresponding to an average breathing rate, and a pressure drop of about 35 millimeters Hg (mm HG) (equivalent to about 0.25 psi) which is the OSHA (Occupational Safety & Health Association) recommended maximum pressure drop across a surgical mask, and a typical 30 minute exposure time. In addition, the viscosity of air as a fluid (μ) is about 0.01 centipoise (which is converted in the calculations to the equivalent value in units of g/cm-sec for consistency). Further, a typical fabric basis weight (Γ) or Areal of 800 g/m2 is selected, being close to the loft of typical air filtration fabrics used in common non-woven synthetic (polymer fiber-based) surgical masks.

Next, considering the size of the selected TIE being the benzene molecule, the two remaining parameters needed to perform the calculations using the formulas presented hereinabove and other parameters as presented in Table 1, is the nominal surface area of the MIP binding site, AMIP, being about 1.0E-14 cm2 or about 1 square nanometer (1 nm2), and a target removal of about 0.45 g of the benzene requiring a total TIE surface area (As) of about 3.09E+4 cm2. Finally, a selected pressure drop limit of about 35 mm Hg (the upper limit of N95 filters as well) and a surface area of less than 150 cm2 (the approximate size of a surgical-type filter mask) are taken as reasonable parameters for modeling the extraction capability of the inventive MIP polymer fibers formed into a web fabric to be used as a filter mask.

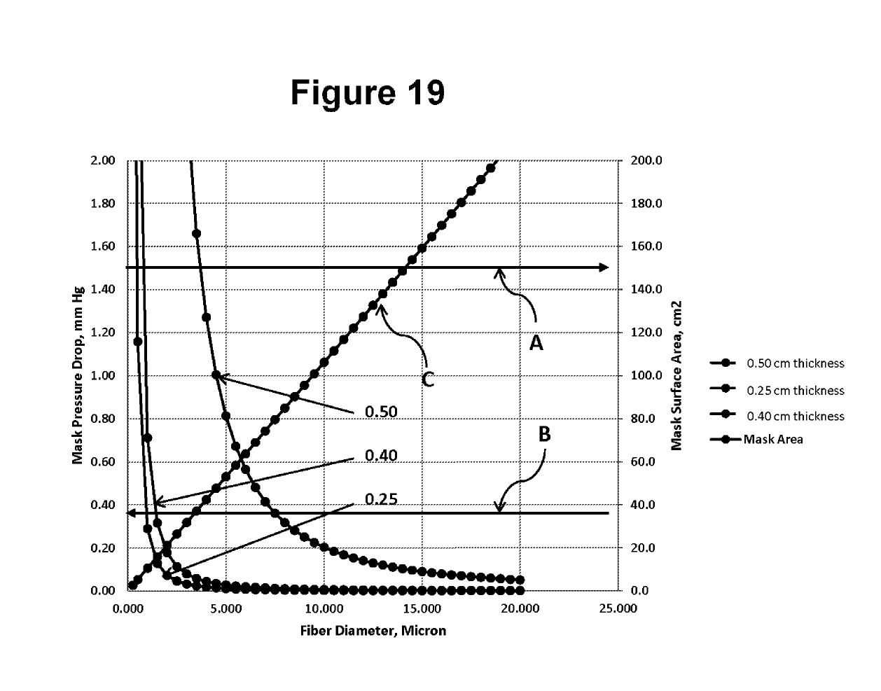

In FIG. 19, the pressure drop (in mm Hg) across a mask filter (in the form of a non-woven fabric web composed of the MIP polymer fibers) having various web thicknesses of 0.25, 0.40 and 0.5 cm are plotted against the primary Y-Axis showing the corresponding pressure drop. The secondary Y-Axis (right) shows the corresponding mask surface area in units of cm2. Here, Line “A” denotes the maximum desired surface area of the mask, or about 150 cm2, the mask area as a function of selected fiber diameter being shown by Line “C”. In this figure, Line “B” represents the maximum recommended pressure drop across the mask, corresponding to about 0.35 mm Hg or about 0.25 psi. The three traces corresponding to the web thickness values, all show acceptable ranges of performance capable of completely adsorbing the total amount of benzene present in the air respired under the estimated flow parameters and conditions discussed above.

Thus, for a mask fabric web thickness of about 0.25 cm, fiber diameters from about 0.5 micron up to about 14 microns in diameter meet the criteria, while for a mask fabric web thickness of 0.50 cm, fiber diameters from about 7.5 micron to about 14 microns meet the criteria, with the range of acceptable fiber diameters for the intermediate web thickness being between these two example embodiments.

Accordingly, the above exampled embodiments for treating a gaseous fluid (air) to remove a selected TIE (benzene) serve to illustrate the broad applications of the inventive MIP polymer fibers and/or webs thereof and/or an apparatus constructed thereof, to remove milligram to gram levels of a selected target imprintable entity (TIE) under low pressure conditions, and also the scalability of the present invention to remove gram to kilogram levels of a TIE under higher pressure conditions, wherein the inventive MIP polymer fiber webs can be constructed by selection of proper fiber diameters, web thickness and Areal fabric loft parameters to meet the needs for efficient flow and effective surface area with a sufficient MIP surface site density sufficient to extract the desired level of TIE under a wide variety of conditions and from a wide variety of fluids include liquids, gases and air.

### Monomers and Polymers Suitable for Use

Polymers suitable for use in forming the inventive MIP polymer fibers disclosed here include a polymer selected from, but not limited to, cellulose acetate, ethylene vinyl alcohol, fluoroplastics, fluoropolymers, ionomers, liquid crystal polymers, melamine formaldehyde, phenol-formaldehyde plastics, polyacetal, polyacrylates, polymethacrylates, polyacrylonitrile, polyacrylonitrile-acrylates, polyamides, polycaprolactone, nylon, nylon 6, nylon “4,6”, nylon “6,6”, nylon 12, polyamide-imides, polyaryletherketone, polybenzimidazole, polybutadiene, polybutylene, polyethylene, polyethlylene-co-vinyl acetate, polyethylene terephthalate, polypropylene, polyalkylenes, polycarbonate, polydicyclopentadiene, polyketone, polylactate, polyester, polyetheretherketone, polyetherimide, polyethersulfone, polyethylene, polyethylenechlorinates, polyimides, polymethylpentene, polyphenylene oxide, polyphenylene sulfide, polyethylene sulfides, polyaminoimides, polyamides, polyaminoakylenes, polyethylene imides, polyphthalamide, polypropylene amides, polystyrene, polysulfone, polyurethane, polyvinyl alcohol, polyvinyl chloride, polyvinylidene chloride, polyvinyl phenol, polyvinhylcarbazoles, rayons, silicone polymers, thermoplastic elastomers, and thermoset polycondensates.

Further, suitable monomers include all monomers used in the synthesis or formation of any one or combination of polymers disclosed herein immediately above.

Further, suitable polymers include any combination of monomers and/or co-monomers that can be polymerized and/or cross-linked to form a MIP polymer; and blends thereof; and co-extrudates thereof; or any other suitable polymers, including, but not limited to naturally-derived polymers, such as for example cellulose, collagen, collagen-polyethylene oxide, and/or synthetically-derived polymers that can be hardened and/or cross-linked and/or condensed and/or reversibly covalently bound and/or reversibly ionically bound to a TIE and/or physically formed around a TIE to form a TIE receptor site and/or template binding region on and/or within the subsequently formed polymer matrix wherein the receptor site or template binding region is capable of adsorbing one or more selected TIEs.

Without being bound by theory, the choice of particular monomers, co-monomers and the resulting polymer formed thereof, are to be selected with regard to creating the most effective template and/or binding and/or receptor site for the intended TIE(s) to be imprinted on and within the polymer, so for hydrophilic TIEs, for example, one trained in the art would employ one or more hydrophilic monomers, co-monomers or polymers to best facilitate the formation of an effective binding site within the subsequently formed solid MIP polymer. In contrast, for a more hydrophobic TIE, one trained in the art would employ one or more hydrophobic monomers or co-monomers or polymers to best facilitate the formation of an effective binding site within the subsequently formed solid MIP polymer.

Additionally, one trained in the art would also consider employing a particular electronically charged group (ionic) such as a net positively charged (cationic) or net negatively charged (anionic) or zwitterionic (dual charged) functionality borne by a monomer, co-monomer or polymer, in order to facilitate the formation of an effective binding site within the subsequently formed solid MIP polymer for a positively or negatively charged TIE or TIE having at least one of a charged group or moiety present.

Additionally, one skilled in the art would also consider employing a specific moiety known to attract, couple, pair, bind, complex, adsorb, absorb or covalently attach to the intended TIE to best facilitate the formation of an effective binding site within the subsequently formed solid MIP polymer.

Further, one skilled in the art would also consider the nature of the fluid(s) to be used in the formation of the MIP polymers as well as the nature of the fluid(s) to be treated as well as the fluid(s) to be used in subsequent extraction, and optionally the fluid(s) to be used in subsequent regeneration of the inventive MIP polymers in the selection of the appropriate monomers, co-monomers, and/or subsequently formed polymers thereof, and/or polymers to best facilitate the formation of an effective binding site within the subsequently formed solid MIP polymer.

MIP Polymer Fiber Web Apparatus with Visual Indicators of Time or Extent of TIE Extraction

It would be desirable to have some means to easily determine whether the inventive MIP polymer fibers have successfully extracted the TIE from the fluid being treated. The removal of caffeine is an instructive example, but is by no means a limiting example of the use of indicators for TIE removal and/or adsorption and/or retention of the target imprintable entities of interest by means of the MIP polymer fibers of the present invention.

While it is known in the art that caffeine imprinted MIP particles can extract the entire amount (or at least a significant fraction thereof to render the resulting coffee essentially free of caffeine) of caffeine present in a typical cup of coffee (160 mg) in less than 5 minutes, the present inventive approach of using MIP polymer fibers with extremely high collective surface areas of TIE receptors favors extremely rapid binding of the target entity owing to the greatly enhanced effective surface area achieved without the concomitant reduction in flow, so that significant degrees of extraction should be achievable on time scales on the order of mere seconds or tens of seconds.

Accordingly, in one embodiment of the present invention, the use of MIP polymer fibers and/or webs thereof and/or apparatus constructed thereof enables complete or significant removal of a TIE from a treated fluid within 5 minutes of contact time. In a further series of embodiments, the inventive MIP polymer fibers enable significantly complete removal of a TIE from a treated fluid within 4 minutes of contact time, and/or alternatively within 3 minutes of contact time, and/or alternatively within 2 minutes of contact time, and/or alternatively within less than or equal to 1 minute of contact time. In yet another series of embodiments, the inventive MIP polymer fibers enable significantly complete removal of a TIE from a treated fluid within 45 seconds of contact time, and/or alternatively within 30 seconds of contact time, and/or alternatively within 15 seconds of contact time.

In another series of embodiments of the present invention regarding the use of the inventive MIP polymer fibers and/or webs thereof and/or apparatus constructed thereof used in a continuous process, enables complete or significant removal of a TIE from a treated fluid within 5 minutes of an effective contact time, wherein an “effective” contact time is the actual and/or calculated transient contact time of exposure of a unit aliquot of the total volume of fluid treated by the inventive MIPs polymer fibers. In alternative embodiments of the invention disclosed immediately above, the inventive MIP polymer fibers enable significantly complete removal of a TIE from a treated fluid within 4 minutes of contact time, and/or alternatively within 3 minutes of contact time, and/or alternatively within 2 minutes of contact time, and/or alternatively within less than or equal to 1 minute of contact time. In yet another series of embodiments, the inventive MIP polymer fibers enable significantly complete removal of a TIE from a treated fluid within 45 seconds of contact time, and/or alternatively within 30 seconds of contact time, and/or alternatively within 15 seconds of contact time, and/or alternatively within 1 second of contact time, and/or alternatively within 0.1 second of contact time; wherein said contact time is the transient contact time of exposure of a unit aliquot of the total volume of fluid treated by the inventive MIPs polymer fibers under conditions of a continuous fluid treatment process.

Accordingly, one means of providing a visual signal to a user to indicate that sufficient treatment time has elapsed to have effectively removed the desired quantity of a TIE from a treated fluid, would be an indicator system that changes color or provides some similar visual indication of elapsed time, the timing of the indicator being selected to correspond to a minimum time required for the inventive MIP polymer fibers to have removed a desired quantity of the targeted entity within that time period. In one embodiment, a MIP polymer fiber in the form of a device having an indicator system could be activated by placement into the fluid, initiating a timed process resulting in a visual indication or color change after a selected elapsed time has occurred, the elapsed time having previously been confirmed as sufficient under the intended use and conditions to have extracted the TIE within the indicated time period communicated to the user of the device.

One such indicator could be, but is not limited to, a brightly colored region on the inventive device that has previously been coated with a slow dissolving substance, preferably an ingestible or food grade or food additive allowed material, that dissolves away slowly over the desired time period to reveal the brightly color signal representing elapsed time. Suitable materials for a coating include, but are not limited to, sugar, starch, titanium dioxide, clay, bentonite, salt and/or any other GRAS (Generally Regarded As Safe) listed or EAFUS (Everything Added to Food in the United States) listed materials approved for use in foods and beverages by the United States Department of Agriculture and Food & Drug Administration (FDA) as published in the Federal Record, both lists hereby being incorporated herein in their entirety by reference.

Alternatively, it would be desirable to pair the inventive MIP polymer fibers, webs and/or an apparatus constructed thereof, with a visual or color indication means that produced a change that corresponded to the actual adsorption of the selected TIE by the inventive MIP polymer fibers, so that the indication was quantitative in nature and indicative or proportional to some extent with the actual amount of TIE material adsorbed.

For inventive embodiments involving caffeine as the TIE to be removed, several indicator systems known in the art could be used or adapted for use with the present invention.

For example, in one embodiment, the caffeine indicator system described by Engelman in U.S. Pat. No. 6,557,484, which is hereby incorporated herein in its entirety by reference, could be fabricated into a device employing MIP polymer fibers imprinted with caffeine and optionally either infused, or co-imprinted with a non-extractable indicator system consisting of xanthine oxidase and/or a peroxidase enzyme, combined with a color changing chromogen as disclosed by Engelman. In this embodiment, binding of caffeine onto the MIP polymer fiber adjacent to a xanthine oxidase or peroxidase moiety results in oxidation of the caffeine (by dissolved oxygen present in atmosphere exposed liquids and particularly water) and release of hydrogen peroxide, which oxidizes the chromogen resulting in a color change that is visible to the human eye, and can be selected to be either one or combination of a 1) color change from one color to another; a 2) disappearance of a color; and/or a 3) development of a color not originally present, and/or a combination of the above to produce any desired visually apparent change that can easily be detected by eye during use of the inventive device.

An example of a commercially available caffeine indicator system that could be coupled with a MIP polymer fiber device according to the present invention, are D+Caf Caffeine Test Strips, available from the Silver Lake Research Corporation, P.O. Box 686, Monrovia, Calif. 91017 USA. These provide a visual indication, using two colored lines, one being a control line and the second a color changing line that indicates, based on its relative intensity compared to the control line, the amount of caffeine remaining after 30 seconds of submersion.

In another embodiment, the caffeine indicator system using a caffeine antibody coupled with a visual dye such as ortho-phenylenediamine contained in a transparent sheath around a wickable core (which would be substituted by the inventive MIP polymer fibers or web formed into a core) as disclosed by Mitchell, et al. in World Pat. Pub. No. WO 1996/027795, which is hereby incorporated herein in its entirety by reference, could be used.

In yet another embodiment, the caffeine indicator system using a nitroblue tetrazolium (NBT) indicator coupled with a peroxidase and a sulfate and coated onto a paper sheath for example around the inventive MIP polymer fibers or web formed into a core, as disclosed by Sand, et al. in U.S. Pub. No. 2002/0192834A1, which is hereby incorporated herein in its entirety by reference, could be used, producing a vibrant blue color change dependent on the level of caffeine present.

In other embodiments, indicator systems that produce a corresponding visual signal, such as for example, but not limited to a color change, visual change, removal of a color, development of a color, darkening or hue change, and/or combinations thereof, is coupled to a device employing the inventive MIP polymer fibers, and/or webs made thereof employed for the extraction of a significant fraction of the selected TIE from a fluid to be treated with the device by submersion into the fluid for a proscribed period of time and optionally stirred or agitated to increase contact with the fluid to facilitate intimate contact between the inventive fibers and/or web and/or device formed thereof.

In one embodiment, the TIE indicator system is positioned and/or incorporated into an upper section of the extraction device that is not normally submerged during the first extraction step of a treatment process, for example, positioned on the other end of the device distal from a lower section of the device containing the MIP polymer fibers and/or web constructed thereof that operates to adsorb the TIE from the fluid during submersion of that lower or distal section into the fluid. As a second step in the above extraction process, the upper section, such as for example, but not limited to, a handle or engagement portion of the device bearing an indicator system that operates to detect remaining levels of the TIE in the treated fluid, is then placed briefly into the treated fluid in order to wet the indicator system with the fluid post-treatment, and such contact operating to initiate an indication cycle of the indicator section, which generates some desired visual signal that is proportional to the detection of the TIE materials as an analyte that remain in the fluid post-treatment.

Ideally, the visual signal operates to provide a positive signal change with respect to the success of the extraction process in removing sufficient TIE from the treated fluid so as to produce a visual difference by the indicator system sufficient at a minimum to distinguish between an untreated state (the original fluid with some quantity of TIE present) and a post-treated state after operation of the device, where the post-treated fluid would have a lower quantity of the TIE present.

Based on the teachings herein any desired type of a further modified filter can be provided by a person of ordinary skill to satisfy a particular extraction of a significant fraction requirement not specifically described.

The above illustration provides many different embodiments or embodiments for implementing different features of the invention. Specific embodiments of components and processes are described to help clarify the invention. These are, of course, merely embodiments and are not intended to limit the invention from that described in the claims. Moreover the attached appendix, which is incorporated herein by reference, includes alternative embodiments.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for extraction of a significant fraction of target imprintable entities from a substantial quantity of fluid sufficient to reduce a fractional quantity of said target imprintable entities in the fluid, wherein the fluid includes a volume that is equal to or greater than one fluid ounce, comprising the steps of:
providing at least one polymeric fibers, said fiber including a sufficient quantity of molecular imprints on at least one surface, thereof, wherein each of said molecular imprints include a shape of at least a portion of at least one of said target imprintable entities; and
contacting said fluid with said polymeric fiber for a period of time sufficient to achieve a reduction of the fractional quantity of said target imprintable entities present within said fluid.

2. The method of claim 1 wherein said target imprintable entity is selected from the group consisting of an atom, metal, molecule, molecular association, molecular complex, compound, toxin, pollutant, virus, bacteria, pathogen, bacteriophage, prion, poison, or a combination thereof.

3. An apparatus comprising a fiber web comprising a plurality of molecularly imprinted polymer fibers; wherein said molecularly imprinted polymer fibers includes a plurality of binding sites receptive to one or more selected target imprintable entities,
wherein said fiber web operates to extract a significant fraction of said target imprintable entities from a fluid containing said entities when said fluid is brought into contact with or flows through said fiber web.

4. The apparatus of claim 3, wherein said significant fraction of said one or more target imprintable entities extracted from a fluid includes a reduction in the amount of at least one of said target imprintable entities remaining in said fluid after a treatment operation; wherein said amount remaining in said fluid after extraction is equal to or less than fifty percent, or alternatively less than twenty five percent, or alternatively less than one percent, or alternatively less than one hundred parts per million, or alternatively less than one part per million, or alternatively less than one part per billion, or alternatively less than one part per trillion with respect to the initial amount of said entity present in said fluid prior to said treatment operation.

5. The apparatus of claim 3, wherein said significant fraction of said one or more target imprintable entities extracted from a fluid after a treatment operation comprises a substantial quantity of said target imprintable entities equal to or greater than one milligram.

6. The apparatus of claim 3, wherein said molecularly imprinted polymer fibers comprise at least one fiber having an effective cross-sectional diameter between 0.25 microns and 100 microns, or alternatively between 0.75 microns and 75 microns, or alternatively between 1 micron and 50 microns.

7. The apparatus of claim 3, wherein said molecularly imprinted polymer fibers comprise at least one fiber having an enhanced surface area amplification factor of greater than or equal to 1.0.

8. The apparatus of claim 3, wherein said fiber web comprises a molecularly imprinted polymer fiber that includes a sufficient quantity of binding sites for said target imprintable entities sufficient to extract a significant fraction of said entities from a fluid containing said entities; wherein said fiber web exhibits a pressure drop across at least one surface of said fiber web; wherein said pressure drop is less than or equal to 100 psi.

9. The apparatus of claim 3, wherein said fiber web comprises one or a plurality of molecularly imprinted polymer fibers formed into a three dimensional structure having an Areal value equal to or greater than 25 g/m², or alternatively equal to or greater than 50 g/m², or alternatively equal to or greater than 75 g/m², or alternatively equal to or greater than 100 g/m², or alternatively equal to or greater than 1000 g/m², or alternatively equal to or greater than 10,000 g/m², or alternatively equal to or greater than 100,000 g/m², or alternatively equal to or greater than 500,000 g/m², or alternatively equal to or greater than 1,000,000 g/m2.

10. The apparatus of claim 3, wherein said fiber web comprises at least one molecularly imprinted polymer fiber having a quantity of binding sites on at least one surface of said fiber exhibiting selective binding affinity to said target imprintable entities; wherein the quantity of said binding sites per unit volume of said fiber web is equal to or greater than 1×10+13/cm³.

11. The apparatus of claim 3, wherein said fiber web exhibits a permeability factor in said fluid equal to or greater than 1×10-5 cm², or alternatively equal to or greater than 1×10-6 cm², or alternatively equal to or greater than 1×10-7 cm², or alternatively equal to or greater than 1×10-8 cm², or alternatively equal to or greater than 1×10-9 cm², or alternatively equal to or greater than 1×10-10 cm², or alternatively equal to or greater than 1×10-11 cm², or alternatively equal to or greater than 1×10-12 cm^{2,} or alternatively equal to or greater than 1×10-13 cm².

12. The apparatus of claim 3, wherein said fiber web operates to extract said significant quantity of said target imprintable entities from said fluid within an effective contact time of less than or equal to 5 minutes.

13. The apparatus of claim 3, wherein said fiber web comprises a web volume of less than or equal to 1000 m³.

14. The apparatus of claim 3, wherein said fiber web has a total combined web thickness of less than or equal to 1000 m.

15. The apparatus of claim 3, wherein said fiber web has a total web area of less than or equal to 100,000 cm².

16. The apparatus of claim 3, wherein said molecularly imprinted polymer fibers feature a quantity of binding sites on their one or more surfaces exhibiting selective binding affinity to said one or more target imprintable entities, and wherein said one or more target imprintable entities is selected from an atom, a molecule, a molecular complex, a molecular association, a compound, a toxin, a pollutant, a virus, a bacteria, a pathogen, a bacteriophage, a prion or a fragment thereof, and combinations thereof that are imprinted onto at least one of said polymer fibers.

17. The apparatus of claim 3, wherein said fluid is selected from liquids, gaseous fluids that are liquids at a selected pressure and temperature condition, carrier gas or liquid in which said one or more target imprintable entities is present as a solubilized material or as a dispersed material or as a suspended material or as an ionized material or as a separated phase within said carrier liquid, gas, gaseous element, gaseous compound, gaseous molecule, air, water, solvent, oil, vegetable oil, fuel, gasoline, diesel fuel, jet fuel, rocket fuel, hydraulic fluid, lubricating fluid, blood, blood diluent, plasma, urine, intestinal fluid, tear, semen, sweat, bodily secretion, consumable beverage, drink, alcohol, wine, beer, juice, liquid extract, liquid food product, ingestible liquid, medicine, injectable liquid, drug, and combinations thereof.

18. A method of regenerating the apparatus according to claim 3 after an operation employing said apparatus to extract a first quantity of said one or more target imprintable entities from a first fluid, comprising the steps of:
isolating said apparatus from said first fluid;
treating said apparatus with a third fluid selected from a solvent, water or combination thereof, in sufficient quantity to substantially displace said one or more entities from said apparatus into said third fluid;
and optionally recovering said quantity of target imprintable entities by subsequently isolating said entities from said third fluid;
wherein said apparatus may then be re-used in a subsequent operation to extract a second quantity of said one or more target imprintable entities from a second fluid;
wherein steps 1 through 3 may be repeated to treat a plurality of liquids.

19. A method of optimizing the parameters of a fiber web for extracting target imprintable entities from a fluid comprising:
selecting a target imprintable entity;
selecting a fluid;
forming a molecularly imprinted polymer fiber imprinted with said target imprintable entity so as to have a least one or a plurality of binding sites receptive to said target imprintable entity;
calculating a first set of parameters of a fiber web using at least one parameter of said fiber corresponding to either the cross-sectional diameter of said fiber or the density of binding sites on said fiber; wherein said first set of parameters of said fiber web are selected from at least one of either the pressure drop across said fiber web in said fluid, areal value of said fiber web, permeability factor of said fiber web in said fluid, fiber web volume or fiber web thickness; and wherein said first set of parameters are initial seed values for the purposes of performing said calculations;
iteratively calculating a second set of parameters of said fiber web wherein said second set of parameters define the physical characteristics of a fiber web that exhibits the desired level of a fractional reduction of said target imprintable entity in said fluid to be treated with said fiber web having properties corresponding to said second set of parameters; wherein said iterative calculations are repeated until the calculated level of said fractional reduction equals or exceeds said desired level of said fractional reduction; thereby resulting in a final set of parameters that define one or more of said fiber web parameters so that said fiber web operates to extract a significant fraction of target imprintable entities from a substantial quantity of fluid sufficient to reduce a fractional quantity of said target imprintable entities in said fluid; and
optionally, forming said molecularly imprinted polymer fiber into a fiber web having properties corresponding to said final set of parameters.

20. The method according to claim 19 wherein said calculated final set of fiber web parameters are optimized in order to maximize the fractional quantity of said target imprintable entities extracted from said fluid; wherein either said desired pressure drop across said fiber web in said fluid or said desired fluid flow rate through said fiber web, or both, are used as initial parameters in said calculation in order to determine optimized values of one or more fiber web parameters selected from fiber web volume, areal value, fiber web density, fiber web thickness, fiber web permeability, and combinations thereof; and wherein said final set of parameters define a fiber web that operates to extract said fractional quantity of said entities from said fluid within a desired contact time with said fiber web.
